(19) United States
(12) Patent Application Publication
(10) Pub. No.: US 2021/0226882 A1
(43) Pub. Date: Jul. 22, 2021

(54) Extending Border Gateway Protocol Link State for Controller

(71) Applicant: Huawei Technologies Co., Ltd., Shenzhen (CN)

(72) Inventor: Huaimo Chen, Bolton, MA (US)

(21) Appl. No.: 17/222,280

(22) Filed: Apr. 5, 2021

Related U.S. Application Data
(63) Continuation of application No. PCT/US2019/054505, filed on Oct. 3, 2019.
(60) Provisional application No. 62/741,759, filed on Oct. 5, 2018.

(51) Int. Cl. H04L 12/715; H04L 12/717; H04L 12/703

(52) U.S. Cl. CPC H04L 45/04; H04L 45/28; H04L 45/42

(57) ABSTRACT

A method for controlling a network that includes encoding, by a central controller, control instructions using an extended Border Gateway Protocol-Link State (BGP-LS) protocol. The central controller is a BGP-LS supported node. The method transmits, by the central controller, the control instructions to nodes in the network that are identified as intended recipients of the control instructions by the central controller and that have established a BGP session with the central controller.

### CROSS-REFERENCE TO RELATED APPLICATIONS

This application claims priority to International Application No. PCT/US2019/054505 filed on Oct. 3, 2019, by Futurewei Technologies, Inc., and titled “Extending Border Gateway Protocol Link State for Controller,” which claims priority to U.S. Provisional Patent Application No. 62/741,759 filed Oct. 5, 2018 by Huaimo Chen and titled “Extending Border Gateway Protocol Link State for Controller,” each of which is incorporated by reference.

### TECHNICAL FIELD

The present application relates to communication networking; and more particularly to extending Border Gateway Protocol-Link State (BGP-LS) for a controller.

### BACKGROUND

A path computation element (PCE) is a device that computes network paths on behalf of the nodes in the network. A PCE can be a router, a server, part of the operations support system, or a virtualized entity running in a cloud. PCE allows for faster updating of path computation policies, reduces costs, and provides the ability to move away from path computation algorithms that are hard coded into router vendor hardware. PCE addresses traffic engineering limitations in large, multi-domain networks where path computation is complex.

PCE is proposed in Internet Engineering Task Force (IETF) for use as a central controller. However, in order to use PCE as a central or Software-Defined Networking (SDN) controller, users have to deploy PCE protocol in their networks. In addition, they need to configure a PCE to obtain the information about network topology from other protocols such as Border Gateway Protocol-Link State (BGP-LS) or Interior Gateway Protocol (IGP). This is complex and expensive and inefficient. Furthermore, a PCE lacks certain controller functions.

### SUMMARY

A first aspect relates to a computer-implemented method for controlling a network. The method includes encoding, by a central controller, control instructions using an extended BGP-LS protocol. The central controller is a BGP-LS supported node. The extended BGP-LS protocol extends BGP-LS, which is the BGP protocol with Link State (LS) extension, to be able to include control instructions and status information as disclosed herein. The method transmits, by the central controller, the control instructions to nodes in the network that are identified as intended recipients of the control instructions by the central controller and that have established a Border Gateway Protocol (BGP) session with the central controller.

In a first implementation form of the computer-implemented method according to the first aspect, the BGP-LS supported node is one of a first route reflector (RR) node or a non-route reflector node.

In a second implementation form of the computer-implemented method according to the first aspect or any preceding implementation of the first aspect, the method transmits, by the central controller, the control instructions to a second route reflector, which sends the control instructions to other nodes in the network that do not have a BGP session with the first route reflector, and that have a BGP session with the second route reflector.

In a third implementation form of the computer-implemented method according to the first aspect or any preceding implementation of the first aspect, the method receives, by the central controller, a status of the execution of the control instructions from a node in the network, the status encoded using the BGP-LS with extensions encoding format. The method records, by the central controller, the status of the execution of the control instructions from the node in the network in a status database.

In a fourth implementation form of the computer-implemented method according to the first aspect or any preceding implementation of the first aspect, the method receives, by the central controller, via the second route reflector, the status of the execution of the control instructions from the node in the network. The method records, by the central controller, the status of the execution of the control instructions from the node in the network in a status database.

A second aspect relates to a computer-implemented method for controlling a network by extending BGP-LS. The method includes receiving, by a network node, control instructions from a SDN controller, the control instructions encoded using a BGP-LS with extensions encoding format. The method executes, by the network node, the control instructions. The method encodes, by the network node, a status of the execution of the control instructions on the network node using the BGP-LS with extensions encoding format. The method transmits, by the network node, the status of the execution of the control instructions on the network node to the SDN controller.

In a first implementation form of the computer-implemented method according to any preceding aspect as such or any preceding implementation form of any preceding aspect, the BGP-LS with extensions encoding format of the control instructions comprise an Instructions Type-Length-Value (TLV) based on a Network Layer Reachability Information (NLRI) node TLV encoding format defined in BGP-LS.

In a second implementation form of the computer-implemented method according to any preceding aspect as such or any preceding implementation form of any preceding aspect, the BGP-LS with extensions encoding format of the Instructions TLV comprises a new Protocol-Identifier (ID), called SDN Controller, information to identify the node in the network, and instructions encoding.

In a third implementation form of the computer-implemented method according to any preceding aspect as such or any preceding implementation form of any preceding aspect, the instructions encoding of the Instructions TLV comprises instructions contents.

In a fourth implementation form of the computer-implemented method according to any preceding aspect as such or any preceding implementation form of any preceding aspect, the instructions encoding of the Instructions TLV comprises an Instructions ID.

In a fifth implementation form of the computer-implemented method according to any preceding aspect as such or any preceding implementation form of any preceding aspect, the BGP-LS with extensions encoding format of the status comprises the Instructions ID when the instructions encoding includes the Instructions ID.

In a sixth implementation form of the computer-implemented method according to any preceding aspect as such or any preceding implementation form of any preceding aspect, the BGP-LS with extensions encoding format of the status comprises the instructions contents when the instructions encoding does not include the Instructions ID.

In a seventh implementation form of the computer-implemented method according to any preceding aspect as such or any preceding implementation form of any preceding aspect, the Instructions ID is a 32-bit identifier contained in an Instructions ID sub-TLV, and wherein the Instructions ID sub-TLV is included in an Instructions TLV.

In an eighth implementation form of the computer-implemented method according to any preceding aspect as such or any preceding implementation form of any preceding aspect, the Instructions ID is contained in a 32-bit identifier field of an Instructions sub-TLV, wherein the Instructions sub-TLV is included in an Instructions TLV.

In a ninth implementation form of the computer-implemented method according to any preceding aspect as such or any preceding implementation form of any preceding aspect, the instructions contents are encoded in Instructions sub-TLVs, each Instructions sub-TLV containing a set of instructions to be applied to the node.

In a tenth implementation form of the computer-implemented method according to any preceding aspect as such or any preceding implementation form of any preceding aspect, the Instructions TLV comprises a Link Descriptor indicating a link to which the set of instructions are applied.

In a eleventh implementation form of the computer-implemented method according to any preceding aspect as such or any preceding implementation form of any preceding aspect, the Instructions TLV comprises a Prefix Descriptor indicating a prefix to which the set of instructions are applied.

In a twelfth implementation form of the computer-implemented method according to any preceding aspect as such or any preceding implementation form of any preceding aspect, the instructions contents are encoded as a set of instructions to be applied to the node in an Instructions sub-TLV, the Instructions sub-TLV being an independent sub-TLV that does not include an Instructions ID, and wherein the Instructions sub-TLV is included in a Node NLRI Instructions TLV.

In a thirteenth implementation form of the computer-implemented method according to any preceding aspect as such or any preceding implementation form of any preceding aspect, the instructions contents are encoded as a set of instructions to be applied to a link in an Instructions sub-TLV, the Instructions sub-TLV being an independent sub-TLV that does not include an Instructions ID, and wherein the Instructions sub-TLV is included in a Link NLRI Instructions TLV.

In a fourteenth implementation form of the computer-implemented method according to any preceding aspect as such or any preceding implementation form of any preceding aspect, the instructions contents are encoded as a set of instructions to be applied to a prefix on a node in an Instructions sub-TLV, the Instructions sub-TLV being an independent sub-TLV that does not include an Instructions ID, and wherein the Instructions sub-TLV is included in a Prefix NLRI Instructions TLV.

In a fifteenth implementation form of the computer-implemented method according to any preceding aspect as such or any preceding implementation form of any preceding aspect, the status of the execution of the control instructions from the node is included in a Status TLV.

In a sixteenth implementation form of the computer-implemented method according to any preceding aspect as such or any preceding implementation form of any preceding aspect, the Status TLV has a format of a NLRI TLV defined in BGP-LS and comprises comprising a newly defined Protocol-ID, called SDN Client, a Controller ID, and a Status Sub-TLV.

In a seventeenth implementation form of the computer-implemented method according to any preceding aspect as such or any preceding implementation form of any preceding aspect, the Status Sub-TLV comprises a Status Brief field that indicates a success/failure of execution of a control instruction and comprises an error code field indicating a type of error when the failure is indicated.

A third aspect relates to network node comprising network communication means, a data storage means, and a processing means, the network node specially configured to perform any preceding aspect as such or any preceding implementation form of any preceding aspect.

For the purpose of clarity, any one of the foregoing aspects or any preceding implementation form of any preceding aspect may be combined with any one or more of the other foregoing aspects and implementation forms to create a new embodiment within the scope of the present disclosure.

These and other features of the various embodiments and advantages thereof will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic diagram illustrating a network that uses a BGP-LS supported node as a controller for transmitting control instructions according to an embodiment of the present disclosure.

FIG. 1B is a schematic diagram illustrating a network that uses a BGP-LS supported node as a controller for receiving status information according to an embodiment of the present disclosure.

FIG. 2A is a schematic diagram illustrating a network that uses a BGP-LS supported node as a controller for transmitting control instructions according to an embodiment of the present disclosure.

FIG. 2B is a schematic diagram illustrating a network that uses a BGP-LS supported node as a controller for receiving status information according to an embodiment of the present disclosure.

FIG. 3A is a schematic diagram illustrating a network that uses a BGP-LS supported node as a controller for transmitting control instructions according to an embodiment of the present disclosure.

FIG. 3B is a schematic diagram illustrating a network that uses a BGP-LS supported node as a controller for receiving status information according to an embodiment of the present disclosure.

FIG. 4 is a schematic diagram illustrating an Instructions TLV according to an embodiment of the present disclosure.

FIG. 5A is a schematic diagram illustrating an Instructions ID sub-TLV according to an embodiment of the present disclosure.

FIG. 5B is a schematic diagram illustrating an Instructions sub-TLV with Instructions ID according to an embodiment of the present disclosure.

FIG. 6 is a schematic diagram illustrating an Instructions TLV with Instructions ID sub-TLV according to an embodiment of the present disclosure.

FIG. 7A is a schematic diagram illustrating an Instructions TLV without an Instructions ID sub-TLV according to an embodiment of the present disclosure.

FIG. 7B is a schematic diagram illustrating an Instructions sub-TLV with an Instructions ID sub-TLV according to an embodiment of the present disclosure.

FIG. 8A is a schematic diagram illustrating a Flow Redirect sub-TLV according to an embodiment of the present disclosure.

FIG. 8B is a schematic diagram illustrating an Instructions sub-TLV with a Flow Redirect sub-TLV according to an embodiment of the present disclosure.

FIG. 9 is a schematic diagram illustrating an Instructions TLV with an Instructions ID sub-TLV and Flow Redirect sub-TLVs according to an embodiment of the present disclosure.

FIG. 10A is a schematic diagram illustrating an Instructions TLV without an Instructions ID sub-TLV according to an embodiment of the present disclosure.

FIG. 10B is a schematic diagram illustrating an Instructions sub-TLV with Instructions ID and a Flow redirect sub-TLV according to an embodiment of the present disclosure.

FIG. 10C is a schematic diagram illustrating an Instructions sub-TLV with an Instructions ID sub-TLV and a Flow redirect sub-TLV according to an embodiment of the present disclosure.

FIG. 11 is a schematic diagram illustrating a Flow sub-TLV according to an embodiment of the present disclosure.

FIG. 12A is a schematic diagram illustrating a Links Action sub-TLV according to an embodiment of the present disclosure.

FIG. 12B is a schematic diagram illustrating a Links Action sub-TLV according to another embodiment of the present disclosure.

FIG. 13A is a schematic diagram illustrating an Adjacency-Service Identifier (SID) sub-TLV according to an embodiment of the present disclosure.

FIG. 13B is a schematic diagram illustrating an Instructions sub-TLV with a Link Actions sub-TLV and a Flow redirect sub-TLV according to an embodiment of the present disclosure.

FIG. 14 is a schematic diagram illustrating an Instructions TLV with Independent sub-TLVs according to an embodiment of the present disclosure.

FIG. 15 is a schematic diagram illustrating an Instructions TLV of type Node Network Layer Reachability Information (NLRI) according to an embodiment of the present disclosure.

FIG. 16 is a schematic diagram illustrating an Instructions TLV of type Link NLRI according to an embodiment of the present disclosure.

FIG. 17 is a schematic diagram illustrating an Instructions TLV of type Prefix NLRI according to an embodiment of the present disclosure.

FIG. 18 is a schematic diagram illustrating a network that uses a BGP-LS element as a SDN controller according to an embodiment of the present disclosure.

FIG. 19 is a schematic diagram illustrating a network that uses a BGP-LS element as a SDN controller according to an embodiment of the present disclosure.

FIG. 20 is a schematic diagram illustrating a Segment Routing (SR) Tunnel sub-TLV according to an embodiment of the present disclosure.

FIG. 21 is a schematic diagram illustrating a Traffic Description sub-TLV according to an embodiment of the present disclosure.

FIG. 22A is a schematic diagram illustrating an Internet Protocol version 4 (IPv4) Forwarding Equivalence Class (FEC) according to an embodiment of the present disclosure.

FIG. 22B is a schematic diagram illustrating an Internet Protocol version 6 (IPv6) FEC according to an embodiment of the present disclosure.

FIG. 23 is a schematic diagram illustrating a Traffic-Description sub-TLV according to another embodiment of the present disclosure.

FIG. 24A is a schematic diagram illustrating a Service Label sub-TLV according to an embodiment of the present disclosure.

FIG. 24B is a schematic diagram illustrating a Service ID sub-TLV according to an embodiment of the present disclosure.

FIG. 25A is a schematic diagram illustrating a Traffic-Description sub-TLV according to an embodiment of the present disclosure.

FIG. 25B is a schematic diagram illustrating a Service Label according to an embodiment of the present disclosure.

FIG. 25C is a schematic diagram illustrating a Service ID according to an embodiment of the present disclosure.

FIG. 26 is a schematic diagram illustrating a SID List sub-TLV according to an embodiment of the present disclosure.

FIG. 27A is a schematic diagram illustrating a Node or Adjacency Identifier (NAI) IPv4 Adjacency according to an embodiment of the present disclosure.

FIG. 27B is a schematic diagram illustrating an NAI IPv6 Adjacency according to an embodiment of the present disclosure.

FIG. 28 is a schematic diagram illustrating a NAI unnumbered adjacency with IPv4 node IDs according to an embodiment of the present disclosure.

FIG. 29 is a schematic diagram illustrating a SID List sub-TLV according to another an embodiment of the present disclosure.

FIG. 30 is a schematic diagram illustrating an Instructions TLV with an Instructions ID TLV according to an embodiment of the present disclosure.

FIG. 31A is a schematic diagram illustrating an Instructions TLV without an Instructions ID sub-TLV according to an embodiment of the present disclosure.

FIG. 31B is a schematic diagram illustrating an Instructions TLV that directly contains an Instructions ID according to an embodiment of the present disclosure.

FIG. 31C is a schematic diagram illustrating an Instructions sub-TLV that contains an Instructions ID sub-TLV according to an embodiment of the present disclosure.

FIG. 32 is a schematic diagram illustrating a Status TLV according to an embodiment of the present disclosure.

FIG. 33A is a schematic diagram illustrating a Status sub-TLV with an Instructions ID according to an embodiment of the present disclosure.

FIG. 33B is a schematic diagram illustrating a Status sub-TLV without an Instructions ID according to an embodiment of the present disclosure.

FIG. 34A is a schematic diagram illustrating a Status sub-TLV with an Instructions ID indicating successful execution of instructions according to an embodiment of the present disclosure.

FIG. 34B is a schematic diagram illustrating a Status sub-TLV without an Instructions ID indicating successful execution of instructions according to an embodiment of the present disclosure.

FIG. 35A is a schematic diagram illustrating a Status TLV without an Instructions ID sub-TLV according to an embodiment of the present disclosure.

FIG. 35B is a schematic diagram illustrating a Status TLV with an Instructions ID sub-TLV according to an embodiment of the present disclosure.

FIG. 36A is a schematic diagram illustrating a Status sub-TLV with an Instructions ID indicating failed execution of instructions according to an embodiment of the present disclosure.

FIG. 36B is a schematic diagram illustrating a Status sub-TLV without an Instructions ID indicating failed execution of instructions according to an embodiment of the present disclosure.

FIG. 37A is a schematic diagram illustrating a Status sub-TLV with an Instructions ID indicating partial failure of the execution of instructions according to an embodiment of the present disclosure.

FIG. 37B is a schematic diagram illustrating a Status sub-TLV without an Instructions ID indicating partial failure of the execution of instructions according to an embodiment of the present disclosure.

FIG. 38 is a flowchart illustrating a method for controlling a network according to an embodiment of the present disclosure.

FIG. 39 is a schematic diagram illustrating a hardware architecture of a network node according to an embodiment of the present disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Embodiments of the present disclosure are employed with various communication standards, including the Interior Gateway Protocol (IGP) and the Border Gateway Protocol-Link State (BGP-LS) aspects of the BGP protocol. BGP is an inter-autonomous system routing protocol designed for Transmission Control Protocol/Internet Protocol (TCP/IP) internets. BGP-LS is the BGP protocol with Link State (LS) extension that is used to carry IGP information over BGP to get link state information.

Generally, the present disclosure describes an additional extension to BGP-LS (referred to herein as extended BGP-LS) that enables a BGP-LS supported node to be a central controller. A BGP-LS supported node is a node that is configured with the capability to communicate using the BGP protocol with LS extension. The extended BGP-LS extends BGP-LS to be able to include control instructions and status information. Using the extended BGP-LS disclosed herein, a BGP-LS supported node is able to be a central controller that is capable of sending control instructions and receive status information between the BGP-LS supported node/central controller and nodes in the network that have a BGP session with the BGP-LS supported node/central controller.

According to an embodiment of the present disclosure, a BGP-LS supported node such as, but not limited to, a route reflector can be configured as a central or SDN controller by utilizing an extension of BGP-LS. A route reflector is a network routing component/node for BGP that advertises an Internal Border Gateway Protocol (IBGP) learned route to another IBGP peer. A route reflector is defined in Request for Comments (RFC) 4456. Use of a route reflector alleviates the need for “full mesh” IBGP. The route reflector acts as a focal point for IBGP sessions. For instance, multiple BGP routers can peer with a route reflector as a central point, rather than peer with every other router in a full mesh. All the other IBGP routers become route reflector clients.

In an embodiment, using a route reflector as a controller, the route reflector sends control instructions using a new extended BGP-LS encoding to every node in a network that the controller wants to execute the control the control instructions and that has a BGP session with the route reflector. For a node in the network that the controller wants to execute the control the control instructions, and does not have a BGP session with the controller, but has a BGP session with another route reflector, the controller sends the instructions to the other route reflector that the node has a BGP session with, which sends the instructions to the node. After a node in the network receives instructions for it from the controller, it executes them and sends the status of the execution to the controller. The controller collects the status from every node in the network that it controls and records it in a database, called a status database. Thus, because BGP-LS can be extended to send control instructions and receive status information, a PCE need not be deployed within the communication network to obtain topology and resource information, thereby saving time, money, and processing resources.

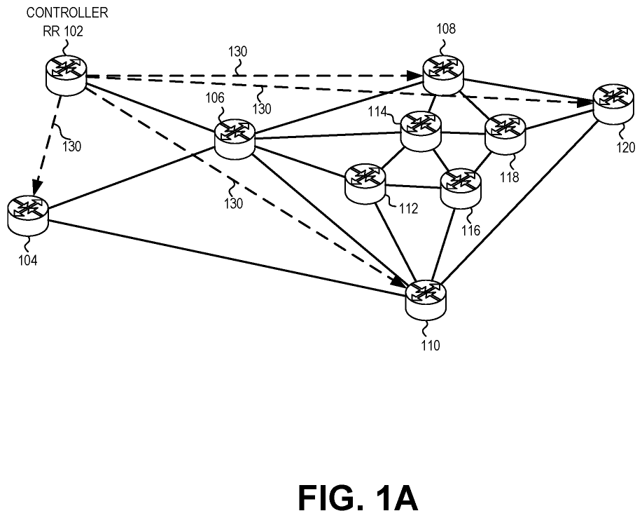

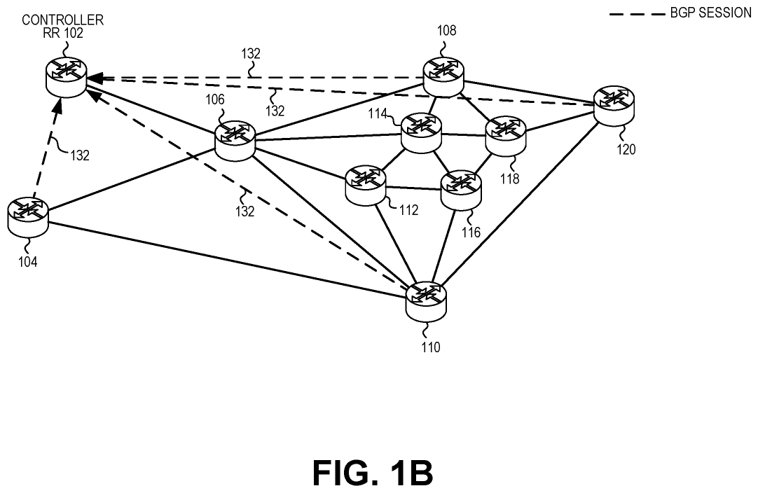

FIG. 1A is a network diagram illustrating the usage of a BGP-LS supported node as a central/SDN controller according to an embodiment of the present disclosure. The network includes a plurality of routers 102-120 coupled to one another via communication links. In the depicted embodiment, router 102 is a route reflector (RR) that is configured as an SDN controller for performing operations according to the present disclosure. As shown, the route reflector 102 established a BGP session with routers 104, 108, 110, and 120. In accordance with the disclosed embodiments, using a new BGP-LS with extensions encoding format as described herein, the route reflector 102 is configured to send control instructions 130 to every node in the network that has a BGP session with the route reflector 102 (e.g., routers 104, 108, 110, and 120) over the BGP session as indicated in FIG. 1A.

After receiving the control instructions 130, the routers 104, 108, 110, and 120 execute the control instructions 130. Using the new BGP-LS with extensions encoding format disclosed herein, the routers 104, 108, 110, and 120 report a status 132 (e.g., success/failure) of the execution of the control instructions 130 back to the route reflector 102 over the BGP session as indicated in FIG. 1B.

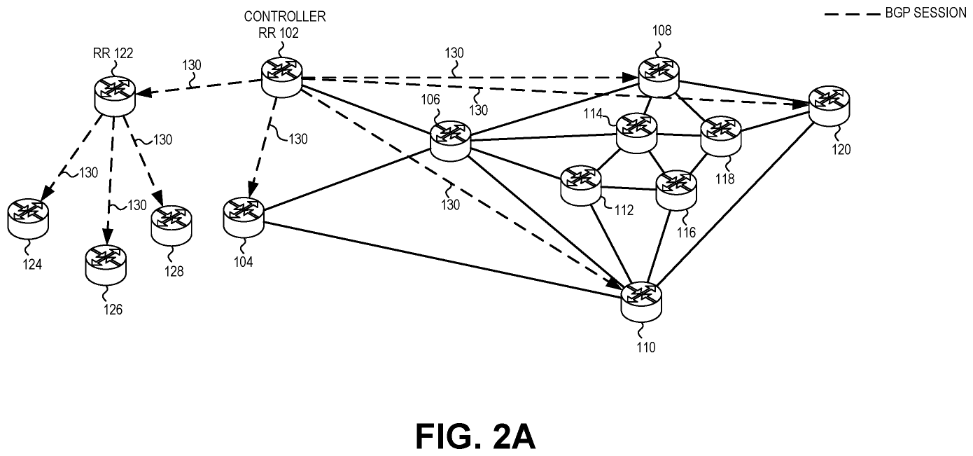

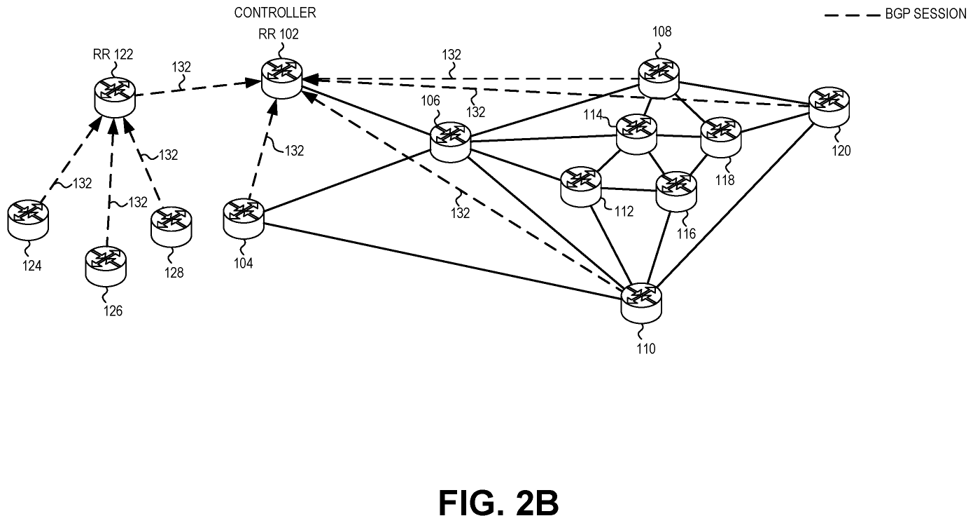

FIG. 2A is a network diagram illustrating the usage of a BGP-LS route reflector as a controller according to an embodiment of the present disclosure. As shown in FIG. 1A, the route reflector 102 is configured to send control instructions 130 to every node in the network that has a BGP session with the route reflector 102. For a node in the network that does not have a BGP session with the route reflector 102 controller (e.g., node 124, node 126, and node 128), but that has a BGP session with another route reflector (e.g., route reflector 122 as shown in FIG. 2A), the route reflector 102 controller sends the instructions 130 to the route reflector 122, which then sends the instructions 130 to the nodes 124, 126, and 128.

After receiving the control instructions 130, the nodes 124, 126, and 128 execute the control instructions 130. Using the new BGP-LS with extensions encoding format disclosed herein, the nodes 124, 126, and 128 report their status 132 of the execution of the control instructions 130 back to the route reflector 122 over the BGP session. The route reflector 122 then routes the status 132 from the nodes 124, 126, and 128 to the route reflector 102 controller as indicated in FIG. 2B.

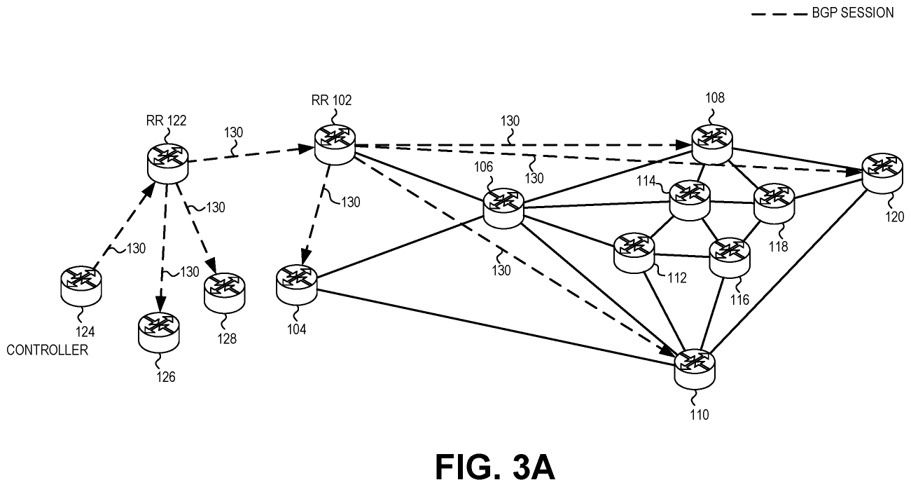

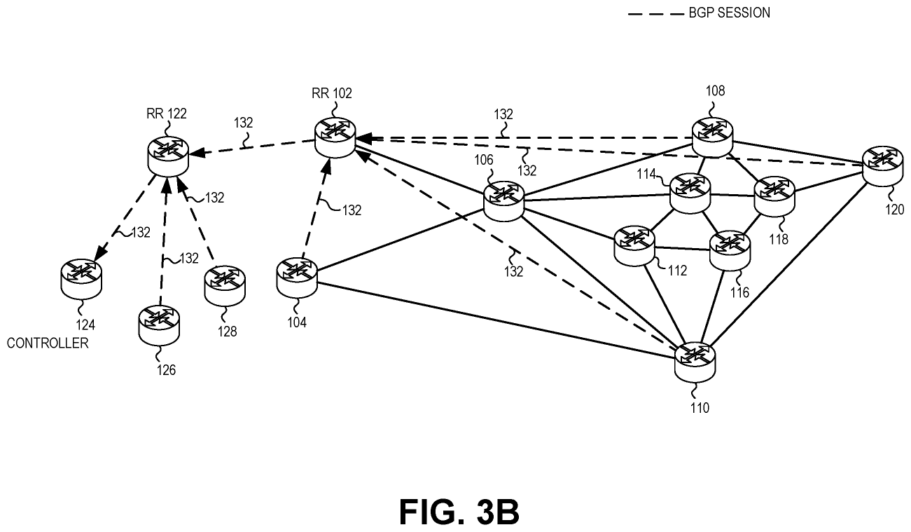

FIG. 3A is a network diagram illustrating the usage of an extended BGP-LS for a non-route reflector BGP-LS supported node as a controller according to an embodiment of the present disclosure. In the depicted embodiment, the node 124 is a non-route reflector BGP-LS supported node (i.e., lacks route reflector capability). The node 124 is configured as a controller. When the controller (node 124) wants to the send control instructions 130 to a node in the network, it sends the control instructions 130, using the new BGP-LS with extensions encoding format, to the route reflector 122 connected to the node 124. The route reflector 122 forwards the instructions 130 to the node 126, node 128, and route reflector 102. The route reflector 102 then forwards the instructions 130 to the nodes in the network that it has a BGP session with.

After receiving the control instructions 130, the nodes execute the control instructions 130. Using the new BGP-LS with extensions encoding format disclosed herein, the nodes report their status 132 of the execution of the control instructions 130 back to the controller/node 124 over the BGP session via the route reflector 122 connected to the node 124 as indicated in FIG. 3B.

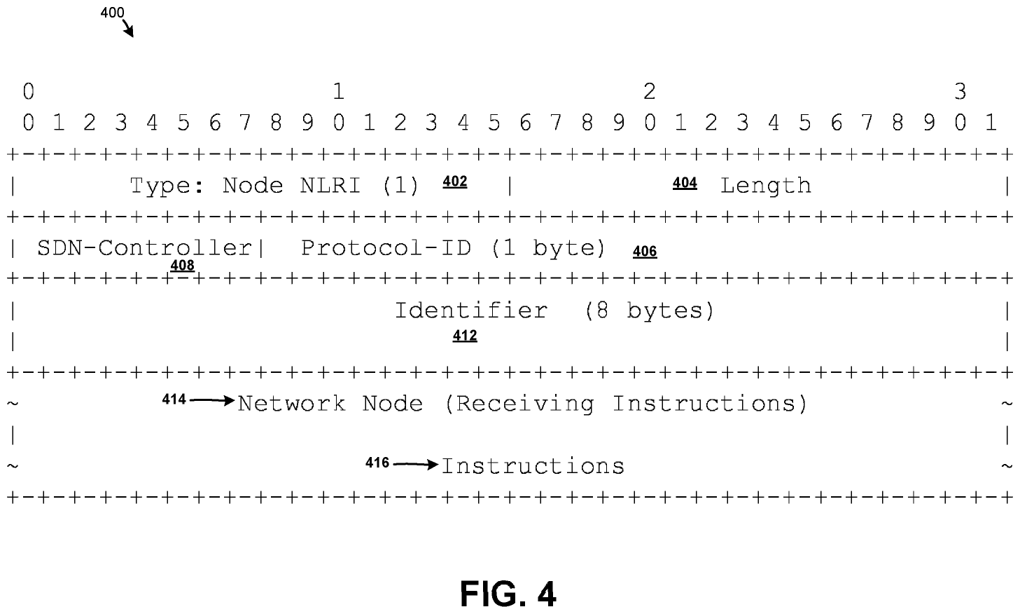

FIG. 4 is a schematic diagram illustrating an encoding of control instructions that can be sent from a SDN controller to a network node according to an embodiment of the present disclosure. The encoded instructions can be sent in a similar manner as instructions 130 described in FIGS. 1A, 2A, and 3A. In an embodiment, the instructions are encoded in a Control Instructions TLV 400 (or Instructions TLV 400 for short) as depicted in FIG. 4. In an embodiment, the Instructions TLV 400 reuses the format of the Node Network Layer Reachability Information (NLRI) TLV defined in BGP-LS (RFC 7752), which includes a Type 402, a Length 404, but defines/uses a new Protocol-ID 406, called SDN Controller 408. The Instructions TLV 400 contains, an Identifier 412, a Network Node 414, and Instructions 416 (e.g., one or more Instructions sub-TLV). The Identifier 412 and the information about the Network Node 414 uniquely identify a node (or a node instance) in a network. The Network Node 414 may reuse the (local) node descriptor defined in BGP-LS RFC 7752. When a node X in the network receives the Instructions TLV 400 and determines that the Network Node 414 and the Identifier 412 uniquely indicate node X, it will accept and execute the Instructions 416 in the Instructions TLV 400. The Instructions 416 encoding can optionally include an Instructions ID that is used to identify a set of instructions.

If no Instructions ID is contained in the Instructions 416 encoding, then after a node receives the instructions and executes them, it has to include the instructions contents when it reports the status of the instructions execution to the controller. However, if an Instructions ID is contained in the Instructions 416 encoding, then after a node receives the instructions and executes them, when the node reports the status of the instructions execution, it includes the Instructions ID and does not need to include the instructions contents.

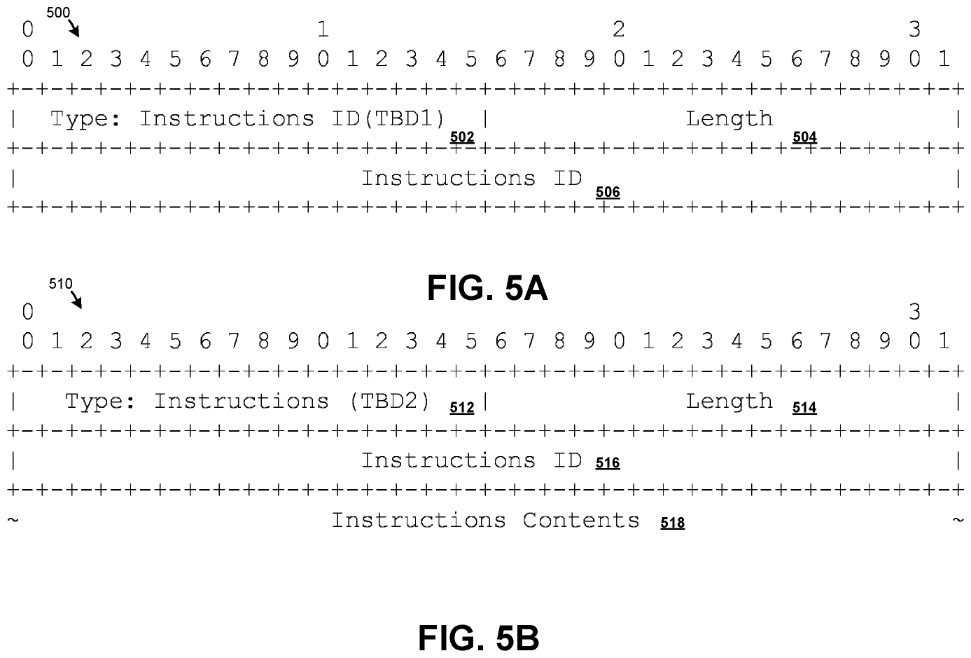

There are many ways to represent the Instructions ID. For example, the Instructions ID may be encoded in an Instructions ID sub-TLV 500 as illustrated in FIG. 5A. The Instructions ID sub-TLV 500 includes a Type 502, Length 504, and Instructions ID 506. The Type 502 indicates that the TLV is an Instructions ID sub-TLV 500. The value for the Type 502 is to be determined (TBD). The Length 504 indicates the number of bytes used by the Instructions ID 506. In an embodiment, the Instructions ID 506 is a fixed 32-bit field containing a 32-bit identifier for the set of instructions.

Another way the Instructions ID can be encoded is directly in an Instructions sub-TLV 510 as illustrated in FIG. 5B. The Instructions sub-TLV 510 includes a Type 512, Length 514, an Instructions ID 516, and Instructions Contents 518. The Type 512 indicates that the TLV is an Instructions sub-TLV 510. The value for the Type 512 is to be determined (TBD). The Length 514 indicates the number of bytes used by the Instructions ID 516 and the Instructions Contents 518. In an embodiment, the Instructions ID 516 is a 32-bit field that is used to identify the set of instructions. The Instructions Contents 518 contains a set of instructions to be applied to the node. For example, the Instructions Contents 518 can contain a Flow Redirect sub-TLV, as further described herein, for instructing the node to redirect a particular packet flow.

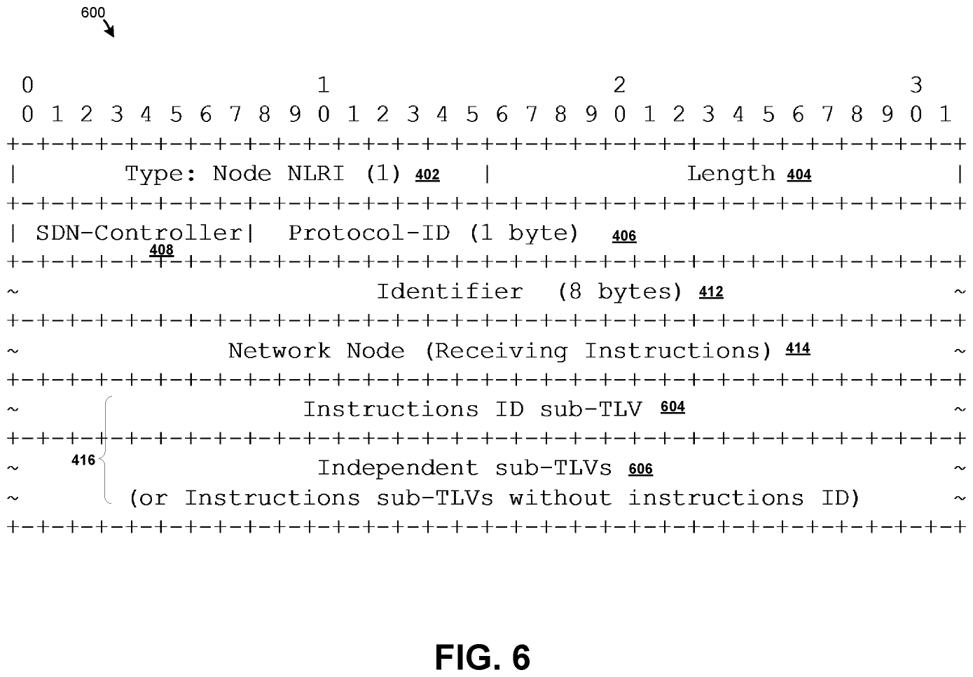

FIG. 6 is a schematic diagram illustrating an Instructions TLV 600 that includes an Instructions ID sub-TLV in accordance with an embodiment of the present disclosure. The Instructions TLV 600 is similar to the Instructions TLV 400 in FIG. 4. In FIG. 6, the Instructions 416 of the Instructions TLV 400 in FIG. 4 are encoded using an Instructions ID sub-TLV 604, and one or more Independent sub-TLVs/Instructions sub-TLVs without Instructions ID 606. The Instructions ID sub-TLV 604 is similar to the Instructions ID sub-TLV 500 in FIG. 5A.

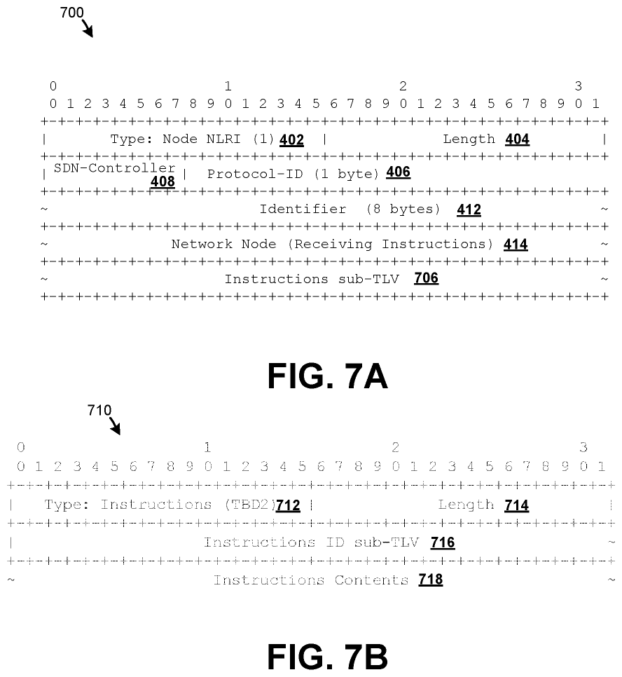

In another embodiment, the Instructions TLV 600 can also be encoded without the Instructions ID sub-TLV 604. For example, FIG. 7A illustrates an Instructions TLV 700 that does not directly contain any Instructions ID sub-TLV. Instead, the Instructions TLV 700 contains an Instructions sub-TLV 706. In an embodiment, the encoding for the Instructions sub-TLV 706 can be similar to the Instructions sub-TLV 510, which includes Instructions Content 518 and a 32-bit field containing an Instructions ID 516 as illustrated in FIG. 5B.

In another embodiment, the encoding for the Instructions sub-TLV 706 in FIG. 7A can be encoded using an Instructions sub-TLV with Instructions ID 710 that is depicted in FIG. 7B. The Instructions sub-TLV with Instructions ID 710 includes a Type 712, Length 714, an Instructions ID sub-TLV 716, and Instructions Contents 718. The Type 712 indicates that the TLV is an Instructions sub-TLV with Instructions ID 710. The value for the Type 712 is to be determined (TBD). The Length 714 indicates the number of bytes used by the Instructions ID sub-TLV 716 and the Instructions Contents 718. In an embodiment, the Instructions ID sub-TLV 716 can be similar to the Instructions ID sub-TLV 500 illustrated in FIG. 5A. The Instructions Contents 718 contains a set of instructions to be applied to the node.

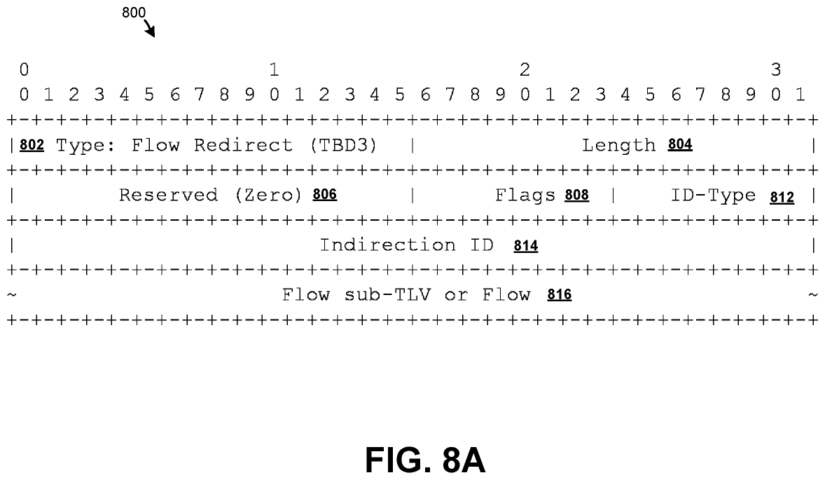

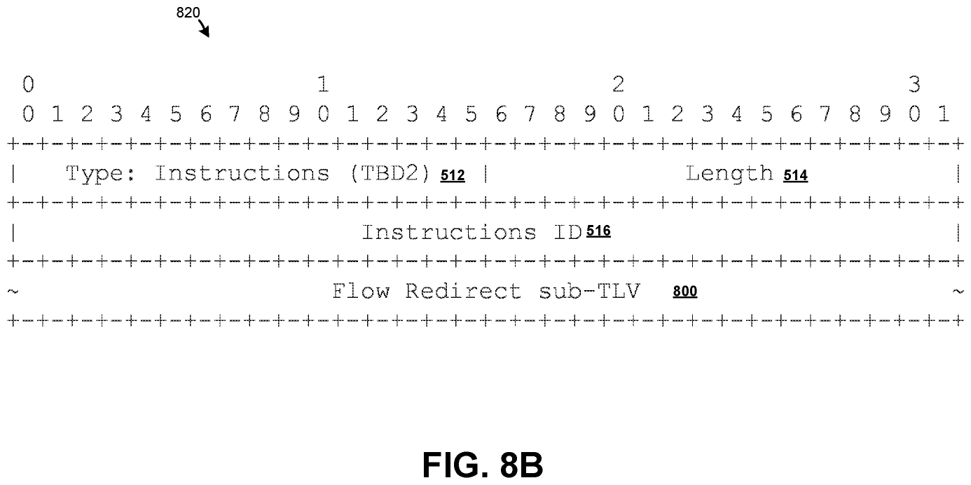

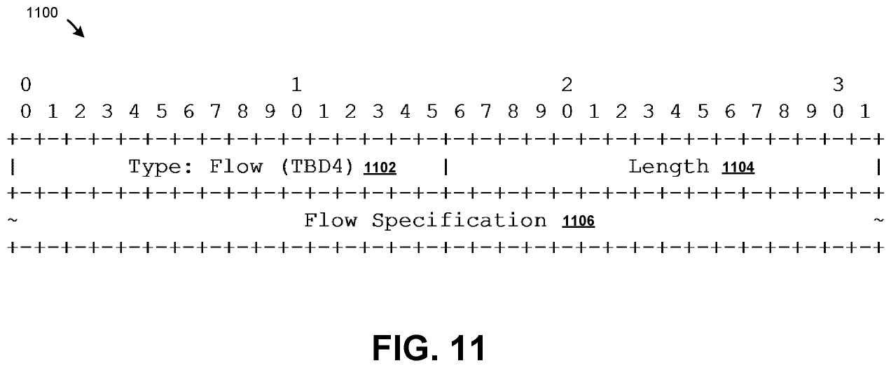

FIG. 8A is a schematic diagram illustrating a Flow Redirect sub-TLV 800 in accordance with an embodiment of the present disclosure. The Flow Redirect sub-TLV 800 is an example of an instructions sub-TLV that can be used to instruct a node to redirect a particular packet flow. The Flow Redirect sub-TLV 800 a Type 802, a Length 804, a Reserved 806, a Flags 808, an ID-Type 812, an Indirection ID 814, and a Flow sub-TLV or Flow 816. The Type 802 indicates that the TLV is a Flow Redirect sub-TLV 800. The value for the Type 802 is to be determined (TBD). The Length 804 indicates the number of bytes used by the Flow Redirect sub-TLV 800 excluding the Type 802 and Length 804. The Reserved 806 can be reserved for future use. The Flags 808 can be used to set certain flags that provide additional information regarding the Indirection ID 814. The ID-Type 812 specifies a type of the Indirection ID 814, which indicates a tunnel that the node is to redirect traffic/flow to. The Flow sub-TLV or Flow 816 specifies the particular flow to redirect. An example of the Flow sub-TLV 816 is illustrated in FIG. 11.

The Flow Redirect sub-TLV 800 can be included in an instructions sub-TLV 820 as illustrated in FIG. 8B. The structure of the instructions sub-TLV 820 is similar to the Instructions sub-TLV 510 in FIG. 5B, with Flow Redirect sub-TLV 800 inserted at the Instructions Content 518 in FIG. 5B.

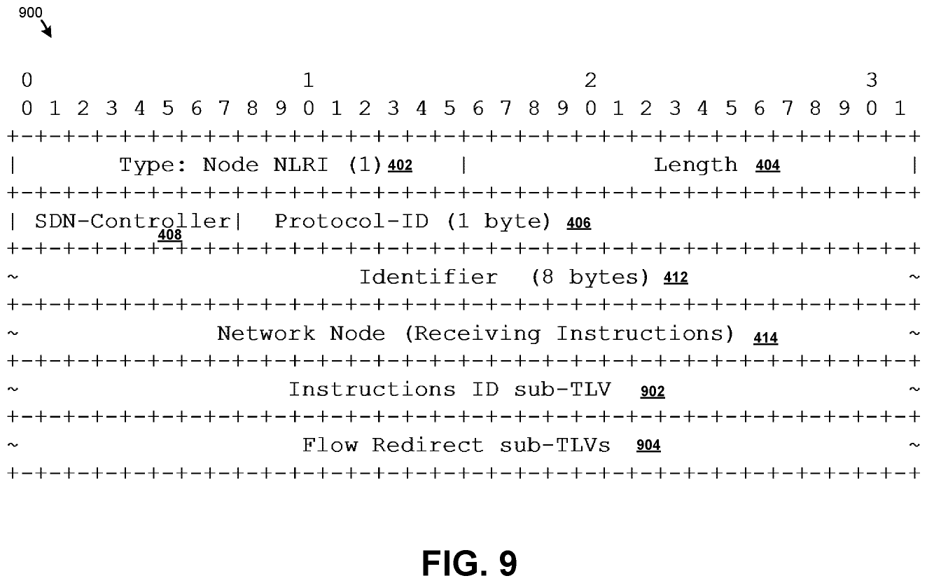

In another embodiment, the Flow Redirect sub-TLV 800 can be inserted directly in an Instructions TLV. For example, FIG. 9 is a schematic diagram illustrating an Instructions TLV 900. The Instructions TLV 900 can have a similar structure and fields to that of the Instructions TLV 400 in FIG. 4. The Instructions TLV 900 further includes an Instructions ID sub-TLV 902, followed by one or more Flow Redirect sub-TLVs 904.

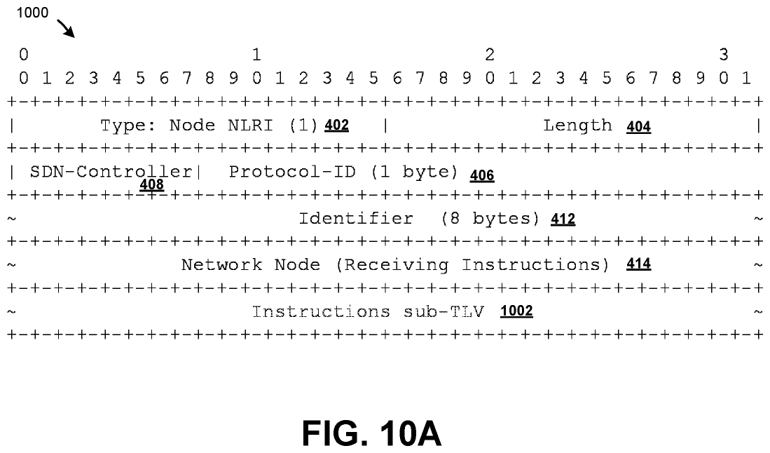

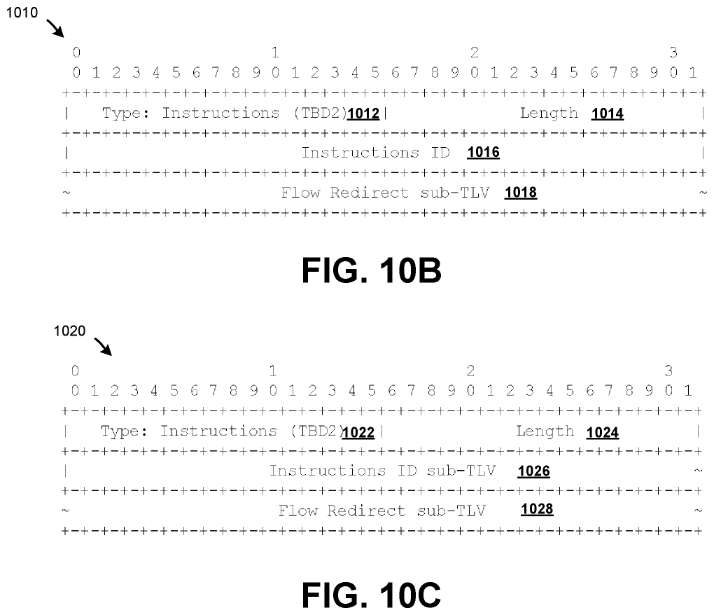

In an alternative embodiment, the Instructions ID may be encoded in an instructions sub-TLV. For example, FIG. 10A illustrates an Instructions TLV 1000 that does not include an Instructions ID sub-TLV such as Instructions ID sub-TLV 902. The Instructions TLV 1000 has the basic structure of the Instructions TLV 400 in FIG. 4. The Instructions TLV 1000 includes one or more Instructions sub-TLVs 1002. The Instructions TLV 1000 does not directly include an Instructions ID sub-TLV. Instead, in an embodiment, an Instructions ID can be included in an Instructions sub-TLV 1002. Two ways to include the Instructions ID in the Instructions sub-TLV 1002 are illustrated in FIG. 10B and FIG. 10C.

FIG. 10B illustrates an Instructions sub-TLV 1010 in accordance with an embodiment of the present disclosure. The Instructions sub-TLV 1010 includes a Type 1012, Length 1014, Instructions ID 1016, and a Flow Redirect sub-TLV 1018. The Type 1012 indicates that the data structure is an Instructions sub-TLV. The value for the Type 1012 is to be determined. The Length 1014 specifies the length of the Instructions sub-TLV 1010 excluding the type 1012 and length 1014. In an embodiment, the Instructions ID 1016 is a 32-bit field that contains an Instructions ID that identifies a set of instructions. In an embodiment, the Flow Redirect sub-TLV 1018 is similar in structure to the Flow Redirect sub-TLV 800 illustrated in FIG. 8A.

FIG. 10C illustrates an Instructions sub-TLV 1020 in accordance with an embodiment of the present disclosure. The Instructions sub-TLV 1020 includes a Type 1022, Length 1024, Instructions ID sub-TLV 1026, and a Flow Redirect sub-TLV 1028. The Type 1022 indicates that the data structure is an Instructions sub-TLV. The value for the Type 1022 is to be determined. The Length 1024 specifies the length of the Instructions sub-TLV 1020 excluding the Type 1022 and Length 1024. In an embodiment, the Instructions ID sub-TLV 1026 is similar in structure to the Instructions ID sub-TLV 500 illustrated in FIG. 5A, which contains an Instructions ID. The Flow Redirect sub-TLV 1028 is similar in structure to the Flow Redirect sub-TLV 800 illustrated in FIG. 8A.

FIG. 11 is a schematic diagram illustrating an instructions sub-TLV for flow, referred to as a Flow sub-TLV 1100, in accordance with an embodiment of the present disclosure. The Flow sub-TLV 1100 includes a Type 1102, Length 1104, and a Flow Specification 1106. The Type 1102 specifies a value (TBD) that indicates that the sub-TLV is a Flow sub-TLV. The Length 1104 specifies the length of the Flow Specification 1106. The Flow Specification 1106 provides traffic flow specifications. In an embodiment, the traffic flow specifications can be directly included in the Flow Specification 1106 of the Flow sub-TLV 1100. Alternatively, the traffic flow specifications can be included in a Flow Redirect sub-TLV (e.g., Flow Redirect sub-TLV 800 illustrated in FIG. 8A), which is then inserted into the Flow Specification 1106 section of the Flow sub-TLV 1100. In an embodiment, the traffic flow specifications contain an n-tuple consisting of several matching criteria that can be applied to Internet Protocol (IP) traffic. A given IP packet is said to match the defined flow if it matches all the specified criteria. Additional information defining a flow specification can be found in RFC 5575.

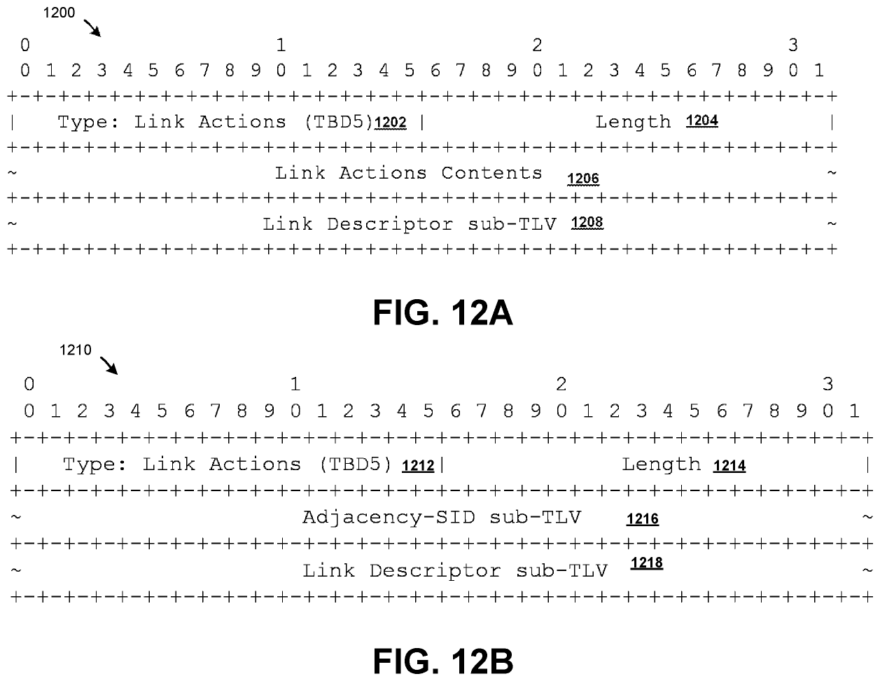

FIG. 12A is a schematic diagram illustrating an example of an instructions sub-TLV (Link Actions sub-TLV 1200) for a link of a node in accordance with an embodiment of the present disclosure. The Link Actions sub-TLV 1200 contains instructions for a node to take some action related to a link or links attached to the node. In an embodiment, the Link Actions sub-TLV 1200 can be included in an Instructions sub-TLV such as the Instructions sub-TLV with Instructions ID 710 depicted in FIG. 7B, which can then be included in an Instructions TLV such as Instructions TLV 400 depicted in FIG. 4. The Link Actions sub-TLV 1200 includes a type 1202, length 1204, Link Actions Contents 1206, and Link Descriptor sub-TLV 1208. The type 1202 specifies a value (TBD) that indicates that the instructions sub-TLV is a Link Actions sub-TLV 1200. The length 1204 specifies the length of the Link Actions sub-TLV 1200, excluding the type 1202 and length 1204. The Link Actions Contents 1206 specifies the actions to take on the specified link of the node. The link is indicated by the Link Descriptor sub-TLV 1208. In an embodiment, the Link Descriptor sub-TLV 1208 contains a set of TLV triplets. The Link Descriptor TLVs uniquely identify a link among multiple parallel links between a pair of anchor routers. A link described by the Link Descriptor TLVs is actually a “half-link”, a unidirectional representation of a logical link. In order to fully describe a single logical link, two originating routers advertise a half-link each, i.e., two Link NLRIs are advertised for a given point-to-point link. An example format of the Link Descriptor TLV can be found in RFC 7752.

FIG. 12B is a schematic diagram illustrating another example of an instructions sub-TLV for links (Link Actions sub-TLV 1210) in accordance with an embodiment of the present disclosure. Similar to the Link Actions sub-TLV 1200, the Link Actions sub-TLV 1210 contains instructions for a node to take some action related to a link attached to the node. The Link Actions sub-TLV 1210 includes a Type 1212, Length 1214, Adjacency-Service Identifier (SID) sub-TLV 1216, and Link Descriptor sub-TLV 1218. The Type 1212 specifies a value (TBD) that indicates that the instructions sub-TLV is a Link Actions sub-TLV 1210. The Length 1214 specifies the length of the Link Actions sub-TLV 1210, excluding the Type 1212 and Length 1214. The Link Descriptor sub-TLV 1218 is similar to the Link Descriptor sub-TLV 1208 in FIG. 12A. The Link Actions sub-TLV 1210 contains the Adjacency-SID sub-TLV 1216 instead of the Link Actions Contents 1206 in the Link Actions sub-TLV 1200. The Adjacency-SID sub-TLV 1216 enables the node to assign an adjacency-SID to a link indicated by the Link Descriptor sub-TLV 1218.

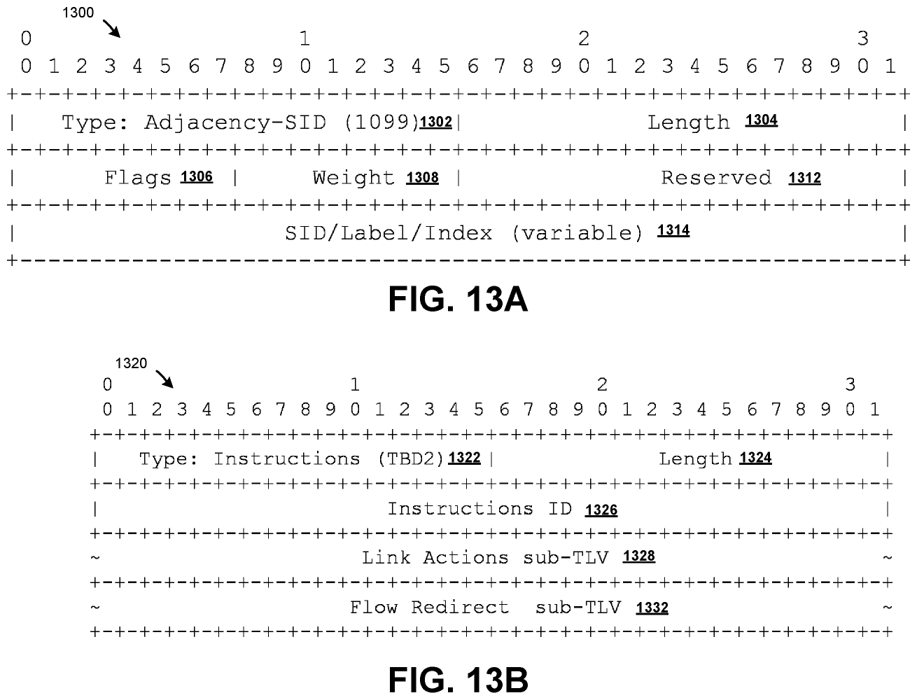

FIG. 13A is a schematic diagram illustrating an Adjacency-SID sub-TLV 1300 in accordance with an embodiment of the present disclosure. The Adjacency-SID sub-TLV 1300 includes a Type 1302, a Length 1304, the Flags 1306, Weight 1308, Reserved 1312, and SID/Label/Index 1314. The Adjacency-SID sub-TLV 1300 is used in order to advertise information related to an Adjacency SID. In an embodiment, the Adjacency-SID sub-TLV 1300 is defined in “BGP Link-State extensions for Segment Routing” draft dated Jun. 27, 2019, draft-ietf-idr-bgp-s-segment-routing-ext-16, hereinafter referred to as BGP-LS extensions Internet-Draft, which assigns a value 1099 to the Adjacency-SID sub-TLV 1300 type 1302. The Length 1304 is of variable size (either 7 or 8 bits depending on SID/Label/Index 1314 encoding). The Flags 1306 is a 1 octet value that can be used to set Intermediate System to Intermediate System (IS-IS) Adj-SID flags and Open Shortest Path First version 2 (OSPFv2)/Open Shortest Path First version 3 (OSPFv3) Adj-SID flags. The Weight 1308 is 1 octet carrying the weight used for load-balancing purposes. In an embodiment, Reserved 1312 is 2 octets that are set to 0 and ignored on receipt. The SID/Label/Index 1314 specifies the SID, label or index value.

FIG. 13B is a schematic diagram illustrating an Instructions sub-TLV 1320 in accordance with an embodiment of the present disclosure. The Instructions sub-TLV 1320 includes a type 1322, length 1324, and Instructions ID 1326. The Instructions ID 1326 is a 32-bit identifier that identifies the instructions in the Instructions sub-TLV 1320. In the depicted embodiment, the Instructions sub-TLV 1320 includes a Link Actions sub-TLV 1328 and a Flow Redirect sub-TLV 1332. Example encodings for the Link Actions sub-TLV 1328 are shown in the Link Actions sub-TLV 1200 in FIG. 12A and the Link Actions sub-TLV 1210 in FIG. 12B. Example encoding for the Flow Redirect sub-TLV 1332 is shown in the Flow Redirect sub-TLV 800 in FIG. 8A. The Instructions sub-TLV 1320 may also contain other instructions for a node and for links attached to the node.

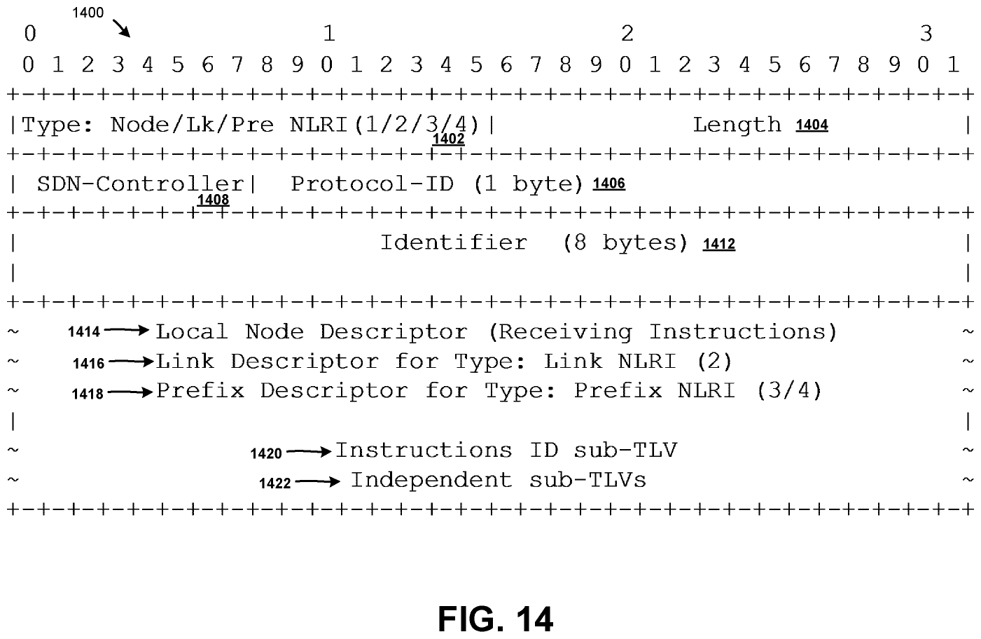

FIG. 14 is a schematic diagram illustrating an Instructions TLV 1400 in accordance with an embodiment of the present disclosure. The Instructions TLV 1400 reuses the format of the NLRI TLV defined in BGP-LS (RFC 7752), which includes a Type 1402 and a Length 1404, but defines/uses a new Protocol-ID 1406, called SDN Controller 1408. The Type 1402 of the Instructions TLV 1400 may have one of the four Types: Node NLRI (1), Link NLRI (2), IPv4 Prefix NLRI (3), and IPv6 Prefix NLRI (4). The SDN Controller 1408 in Protocol-ID 1406 implies that the independent sub-TLVs represent the instructions. The Identifier 1412 and the Local Node Descriptor 1414 uniquely identify a node (or a node instance) in a network. The Local Node Descriptor 1414 may reuse the (local) node descriptor defined in BGP-LS RFC 7752. The Instructions TLV 1400 can include Link Descriptor 1416 when the type 1402 is Link NLRI (2). Similarly, the Instructions TLV 1400 can include Prefix Descriptor 1418 when the type 1402 is IPv4 Prefix NLRI (3) or IPv6 Prefix NLRI (4). The Instructions TLV 1400 includes an Instructions ID sub-TLV 1420 such as Instructions ID sub-TLV 500 in FIG. 5A that contains an Instructions ID. The Instructions TLV 1400 can include a number of independent sub-TLVs 1422 as instructions in the Instructions TLV 1400.

An independent sub-TLV is an existing sub-TLV or a new sub-TLV that does not contain an Instructions ID. For example, an adjacency-SID sub-TLV defined in the BGP-LS extensions Internet-Draft is an independent sub-TLV. The Flow Redirect sub-TLV 800 in FIG. 8A is a new independent sub-TLV defined in this disclosure. For independent sub-TLVs, the instructions role of the independent sub-TLV is implied by the Protocol ID (SDN Controller), and the target of the independent sub-TLV is implied by the type of NLRI in which the independent sub-TLV is included. For example, for instructions to be applied to a node, the sub-TLV is included in a Node NLRI TLV. The local node descriptor in the Node NLRI TLV indicates the node to which the instructions apply. For instructions to be applied to a link on a node, the sub-TLV is included in a Link NLRI TLV. The local node descriptor and the link descriptor in the Link NLRI TLV indicate the link on the node to which the instructions apply. For instructions to be applied to a prefix on a node, the sub-TLV is included in a Prefix NLRI TLV. The local node descriptor and the prefix descriptor in the Prefix NLRI TLV indicate the prefix on the node to which the instructions apply. Note that instructions encoding may just contain the instructions contents without any Instructions ID.

Although using an independent sub-TLV requires fewer changes, using an instructions sub-TLV is more efficient because a number of different sets of instructions may be included in a sub-TLV in a Node NLRI TLV. For example, the sub-TLV may contain some sub-TLVs for a number of sets of instructions to be applied to a node, some sub-TLVs for another number of sets of instructions to be applied to some of the links on the node, and some sub-TLVs for sets of instructions to be applied to some prefixed on the node. In contrast, for independent sub-TLVs, the sub-TLV for instructions to be applied to a node needs to be included in a Node NLRI TLV, the sub-TLV for instructions to be applied to a link needs to be included in a Link NLRI TLV, and the sub-TLV for instructions to be applied to a prefix needs to be included in a Prefix NLRI TLV.

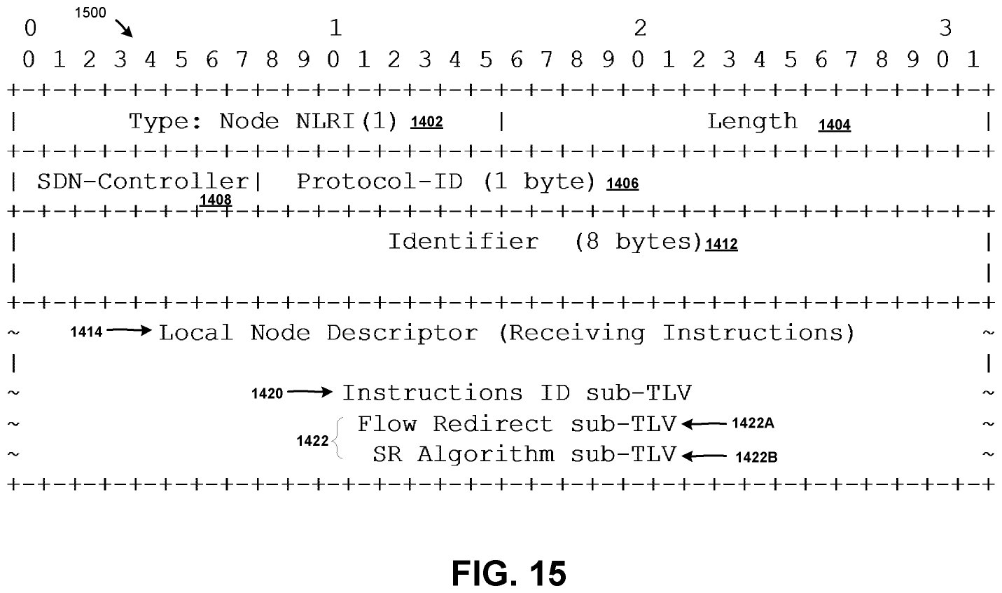

FIG. 15 is a schematic diagram illustrating Instructions TLV 1500 in accordance with another embodiment of the present disclosure. The Instructions TLV 1500 is an example implementation of the Instructions TLV 1400 in FIG. 14, where the type 1402 is a Node NLRI (1). The Instructions TLV 1500 also includes the length 1404, the SDN Controller 1408, which is a Protocol-ID 1406 of one byte, Identifier 1412, the Local Node Descriptor 1414, and the Instructions ID sub-TLV 1420 as described in FIG. 14. The Instructions TLV 1500 includes a Flow Redirect sub-TLV 1422A and a Segment Routing (SR) Algorithm sub-TLV 1422B defined in the BGP-LS extensions Internet-Draft as the independent sub-TLVs 1422. The SDN Controller 1408 in the Protocol-ID 1406 implies that the Flow Redirect sub-TLV 1422A and SR Algorithm sub-TLV 1422B represent the instructions to be applied to a node, which is indicated by the Local Node Descriptor 1414 and the Identifier 1412 in the Instructions TLV 1500. The Flow Redirect sub-TLV 1422A instructs the node to redirect the flow to a tunnel given by an indirection ID in the Flow Redirect sub-TLV 1422A. The SR Algorithm sub-TLV 1422B may instruct the node to use the algorithm in the SR Algorithm sub-TLV 1422B for some SR related work. For example, an SR router can use various algorithms when calculating reachability to OSPF routers or prefixes in an OSPF area. An SR router can advertise the algorithms currently used by the router to other routers in an OSPF area. All these instructions can be identified using the Instructions ID in the Instructions ID sub-TLV 1420.

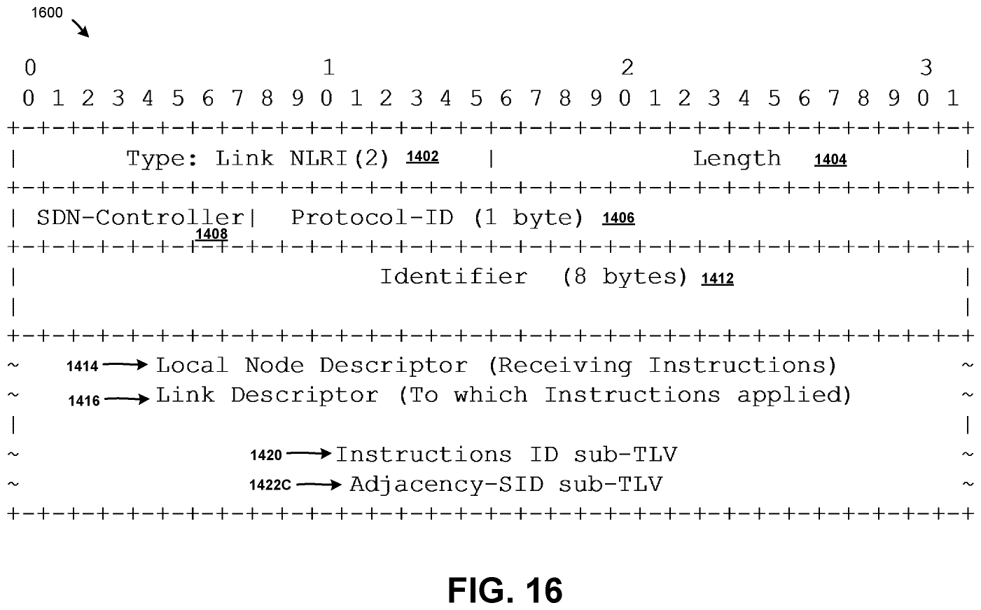

FIG. 16 is a schematic diagram illustrating Instructions TLV 1600 in accordance with an embodiment of the present disclosure. The Instructions TLV 1600 is another example implementation of the Instructions TLV 1400 in FIG. 14, where the type 1402 is a Link NLRI (2). The Instructions TLV 1600 also includes the length 1404, the SDN Controller 1408, which is a Protocol-ID 1406 of one byte, Identifier 1412, the Local Node Descriptor 1414, and the Instructions ID sub-TLV 1420 as described in FIG. 14. The Instructions TLV 1600 includes the Link Descriptor 1416 because the type 1402 is Link NLRI (2). The Instructions TLV 1600 includes an Adjacency-SID sub-TLV 1422C as defined in the BGP-LS extensions Internet-Draft. The SDN Controller 1408 in the Protocol-ID 1406 implies that the Adjacency-SID sub-TLV 1422C represents the instructions to be applied to a link attached to a node, which is indicated by the Local Node Descriptor 1414 and the Identifier 1412 in the Instructions TLV 1600. The link is indicated by the Link Descriptor 1416 in the Instructions TLV 1600. The Adjacency-SID sub-TLV 1422C instructs the node to use the Adjacency-SID indicated in the Adjacency-SID sub-TLV 1422C for the link indicated by the Link Descriptor 1416.

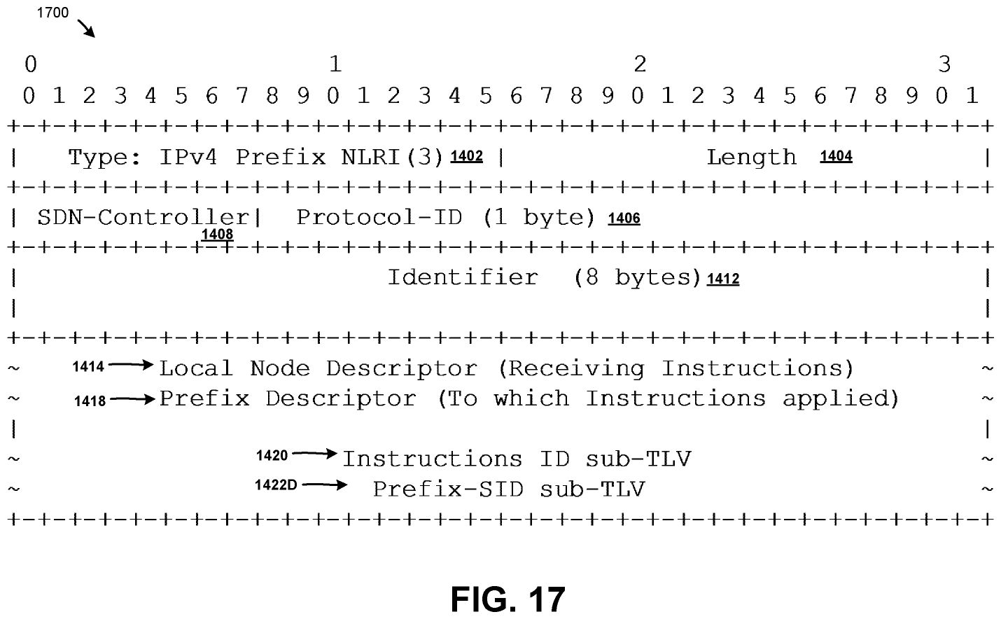

FIG. 17 is a schematic diagram illustrating Instructions TLV 1700 in accordance with an embodiment of the present disclosure. The Instructions TLV 1700 is another example implementation of the Instructions TLV 1400 in FIG. 14, where the type 1402 is an IPv4 Prefix NLRI (3). The Instructions TLV 1700 also includes the length 1404, the SDN Controller 1408, which is a Protocol-ID 1406 of one byte, Identifier 1412, the Local Node Descriptor 1414, and the Instructions ID sub-TLV 1420 as described in FIG. 14. The Instructions TLV 1700 includes the Prefix Descriptor 1418 because the type 1402 is IPv4 Prefix NLRI (3). The Instructions TLV 1700 includes a Prefix-SID sub-TLV 1422D as defined in the BGP-LS extensions Internet-Draft. The SDN Controller 1408 in the Protocol-ID 1406 implies that the Prefix-SID sub-TLV 1422D represents the instructions to be applied to a prefix attached to a node, which is indicated by the Local Node Descriptor 1414 and the Identifier 1412 in the Instructions TLV 1700. The prefix to which the set of instructions are applied is indicated by the Prefix Descriptor 1418 in the Instructions TLV 1700. The Prefix-SID sub-TLV 1422D instructs the node to use the Prefix-SID indicated in the Prefix-SID sub-TLV 1422D for the prefix indicated by the Prefix Descriptor 1418.

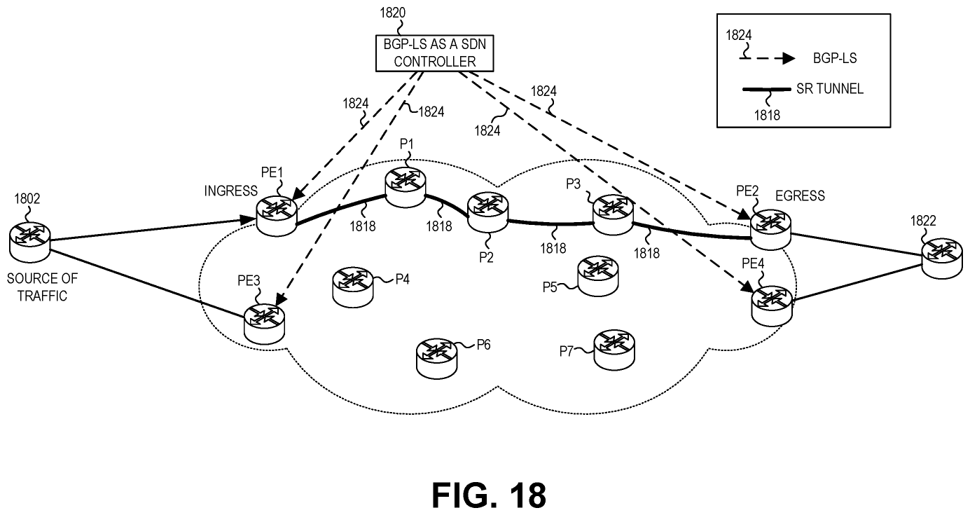

FIG. 18 is a network diagram illustrating the usage of a BGP-LS element 1820 as a SDN controller for creating a SR tunnel 1818 according to an embodiment of the present disclosure. In the depicted embodiment, Customer Edge Router (CE) 1802 is the source of the data traffic, and CE router 1822 is the destination for the data traffic. The BGP-LS element/SDN controller 1820 computes a path, which is from an ingress node (e.g., Provider Edge Router (PE) PE1) to an egress node (e.g., PE2) for creating the SR tunnel 1818 (e.g., the SR tunnel 1818 from PE1 to PE2 via provider router (P) P1, P2, and P3). The path satisfies given constrains if any constraints are given. The BGP-LS element/SDN controller 1820 prepares for the creation of the SR tunnel 1818 along the path by allocating a list of SIDs or labels for the SR tunnel 1818 along the path. The BGP-LS element/SDN controller 1820 stores the list and associates the list with the SR tunnel 1818.

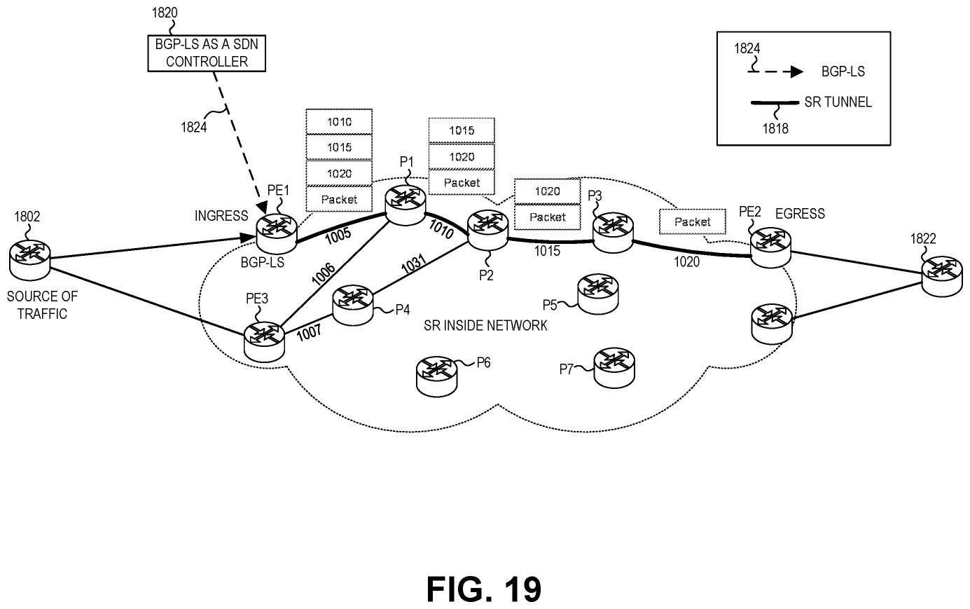

As an example, referring to FIG. 19, suppose that nodes P1, P2, P3, and PE2 have their node-SIDs 100, 200, 300, and 500 respectively. The links between PE1 to P1, PE3 to P1, P1 to P2, P2 to P3, and P3 to PE2 have their adjacency-SIDs 1005, 1006, 1010, 1015, and 1020 respectively. In one example, the path PE1 to P1 to P2 to P3 to PE2 for the SR tunnel 1818 is computed by the BGP-LS element/SDN controller 1820, which satisfies a set of constraints, but is not a shortest path from PE1 to PE2. The list of SIDs {1005, 1010, 1015, and 1020} for the SR tunnel 1818 is allocated and sent to PE1 by the BGP-LS element/SDN controller 1820. In an embodiment, the BGP-LS element/SDN controller 1820 sends the ingress node the following: the information needed for creating the SR tunnel 1818 that consists of a segment list; traffic description, which describes the traffic that the SR tunnel 1818 carries; and service SID/Label if any, which indicates the service such as Virtual Private Network (VPN) service that the SR tunnel 1818 transports.

After receiving the list from the BGP-LS element/SDN controller 1820, the ingress node PE1 creates a forwarding entry in its forwarding information base (FIB). The forwarding entry will Import packets/traffic according to the traffic description for the SR tunnel 1818; Push the service SID/Label (if any) into each of the packets to be imported into the SR tunnel 1818; Push the list of SIDs/Labels for the SR tunnel 1818 into each of the packets to be imported into the SR tunnel 1818; and Send the packets to the direct downstream node of the ingress node along the SR tunnel 1818. For example, in the depicted embodiment, the forwarding entry adds {1010, 1015, and 1020} into the packet and sends the packet to P1 through the link from PE1 to P1. For a packet imported into the SR tunnel 1818, PE1 adds {1010, 1015, and 1020} to the packet and sends packets to P1 through the link from PE1 to P1. The ingress node PE1 sends the BGP-LS element/SDN controller 1820 a status report to indicate that the execution of instructions for creating SR tunnel 1818 is successful after the forwarding entry is created successfully. The BGP-LS element/SDN controller 1820 records the status of the SR tunnel 1818 based on the status report received from the ingress node PE1.

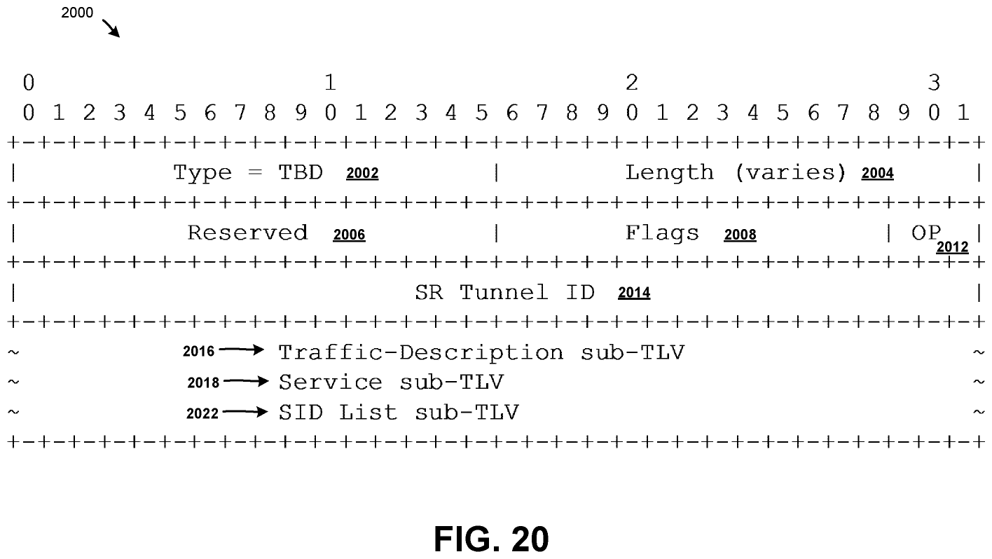

FIG. 20 is a schematic diagram illustrating a SR tunnel sub-TLV 2000 in accordance with an embodiment of the present disclosure. The SR tunnel sub-TLV 2000 is a new sub-TLV defined for operations on a SR tunnel. The SR tunnel sub-TLV 2000 can be used when a BGP-LS as an SDN controller (e.g., the BGP-LS element/SDN controller 1820 in FIG. 18) sends an Instructions TLV for creating or deleting a SR tunnel (e.g., SR tunnel 1800 in FIG. 18) to the ingress node (e.g., PE1 in FIG. 18) of the tunnel. In one embodiment, the Instructions TLV contains the SR tunnel sub-TLV 2000 in an Instructions sub-TLV. In the depicted embodiment, the SR tunnel sub-TLV 2000 includes Type 2002, Length 2004, Reserved 2006, FLAGS 2008, operation (OP) 2012, SR Tunnel ID 2014, Traffic-Description sub-TLV 2016, Service sub-TLV 2018, and SID List sub-TLV 2022. The type 2002 specifies a value (TBD) that indicates that the sub-TLV is a SR tunnel sub-TLV. The Length 2004 specifies the length of the SR tunnel sub-TLV 2000 excluding the Type 2002 and Length 2004 fields. The Reserved 2006 is reserved for future use. The Flags 2008 can be used to indicate certain flags related to the SR tunnel sub-TLV 2000. In an embodiment, the OP 2012 is a 3-bit field and can be used to indicate an SR tunnel operation (e.g., OP=1: Create SR tunnel, OP=2: Delete SR tunnel identified by SR Tunnel ID 2014). The SR tunnel ID 2014 is 32 bits and is used to identify a SR tunnel. Traffic-Description sub-TLV 2016 describes the traffic to be imported into the SR tunnel. Service sub-TLV 2018 contains a service label or ID to be added into a packet to be carried by SR tunnel. SID List sub-TLV 2022 contains an ordered list of SIDs for the SR tunnel to be created. If the operation is to delete an SR tunnel (e.g., OP=2), the SR Tunnel sub-TLV 2000 does not include any sub-TLV such as the Traffic-Description sub-TLV 2016, Service sub-TLV 2018, and SID List sub-TLV 2022.

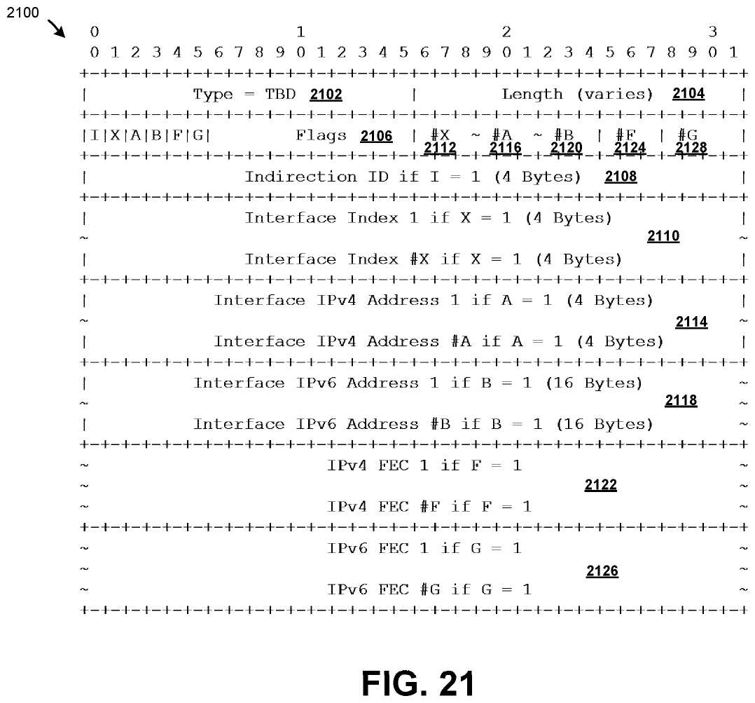

FIG. 21 is a schematic diagram illustrating a Traffic-Description sub-TLV 2100 according to an embodiment of the present disclosure. The Traffic-Description sub-TLV 2100 is an example a sub-TLV for traffic description, such as, the Traffic-Description sub-TLV 2016 in FIG. 20. The Traffic-Description sub-TLV 2100 includes Type 2102, Length 2104, and Flags 2106. The Type 2102 specifies a value (TBD) that indicates that the sub-TLV is a Traffic-Description sub-TLV 2100. The Length 2104 specifies the length of the Traffic-Description sub-TLV 2100 excluding the Type 2102 and Length 2104 fields.

In an embodiment, the Flags 2106 includes an I flag, an X Flag, an A Flag, a B Flag, an F flag, and a G flag. The I flag is an Indirection ID flag. It is set to one (1) to indicate that an Indirection ID 2108 of 32 bits (i.e., 4 bytes) is included in the Traffic Description sub-TLV 2100. The I flag is set to zero (0) to indicate that no indirection ID 2108 is included. The X Flag is an Interface Index flag. The X Flag is set to one (1) to indicate that Interface Indexes 2110 are included in the Traffic Description sub-TLV 2100. The number of interface indexes is given by 3-bit value in the #X field 2112. In an embodiment, each interface index 2210 is 32 bits (i.e., 4 bytes). The X Flag is set to zero (0) to indicate that no interface index 2110 is included in the Traffic Description sub-TLV 2100. The A Flag is an Interface IPv4 Address flag. The A Flag is set to one (1) to indicate that Interface IPv4 Addresses 2114 are included in the Traffic Description sub-TLV 2100. The number of interface IPv4 Addresses 2114 is given by a 3-bit value in the #A field 2116. In an embodiment, each interface IPv4 Address 2114 is 32 bits (i.e., 4 bytes). The A Flag is set to zero (0) to indicate that no interface IPv4 Address 2114 is included in the Traffic Description sub-TLV 2100. The B Flag is an Interface IPv6 Address flag. The B Flag is set to one (1) to indicate that Interface IPv6 Addresses 2118 are included in the Traffic Description sub-TLV 2100. The number of interface IPv6 Addresses 2118 is given by a 3-bit value in the #B field 2120. Each interface IPv6 Address 2118 is 128 bits (i.e., 16 bytes). The B Flag is set to zero (0) indicating that no interface IPv6 Address 2118 is included in the Traffic Description sub-TLV 2100. The F Flag is an IPv4 Forwarding Equivalence Class (FEC) flag that is set to one (1) to indicate that IPv4 FECs 2122 are included in the Traffic Description sub-TLV 2100. The number of IPv4 FECs 2122 included in the Traffic Description sub-TLV 2100 is given by a 3-bit value in the #F field 2124. The F Flag is set to zero (0) to indicate that no IPv4 FEC 2122 is included in the Traffic Description sub-TLV 2100. The G Flag is an IPv6 FEC flag that is set to one (1) to indicate that IPv6 FECs 2126 are included in the Traffic Description sub-TLV 2100. The number of IPv6 FECs 2126 in the Traffic Description sub-TLV 2100 is given by a 3-bit value in the #G field 2128. The G Flag is set to zero (0) to indicate that no IPv6 FEC is included in the Traffic Description sub-TLV 2100.

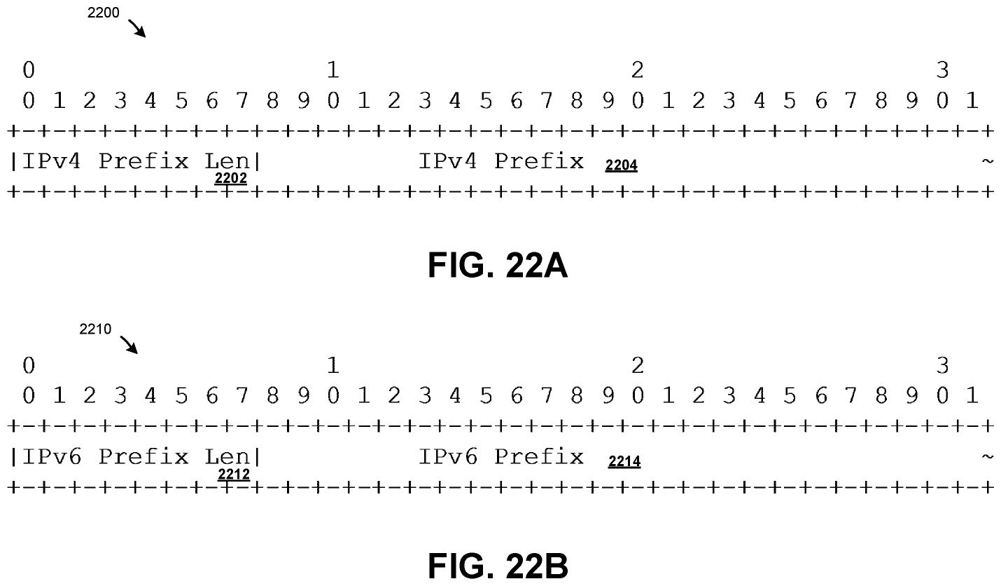

FIG. 22A is a schematic diagram illustrating an IPv4 FEC 2200 according to an embodiment of the present disclosure. The IPv4 FEC 2200 is an example of the IPv4 FECs 2122 in the Traffic Description sub-TLV 2100 in FIG. 21. The IPv4 FEC 2200 contains an IPv4 Prefix Length field 2202 of 8 bits indicating the length (i.e., number of bits) of the IPv4 Prefix 2204.

FIG. 22B is a schematic diagram illustrating an IPv6 FEC 2210 according to an embodiment of the present disclosure. The IPv6 FEC 2210 is an example of the IPv6 FECs 2126 in the Traffic Description sub-TLV 2100 in FIG. 21. The IPv6 FEC 2210 contains an IPv6 Prefix Length field 2212 of 8 bits indicating the length (i.e., number of bits) of the IPv6 Prefix 2214.

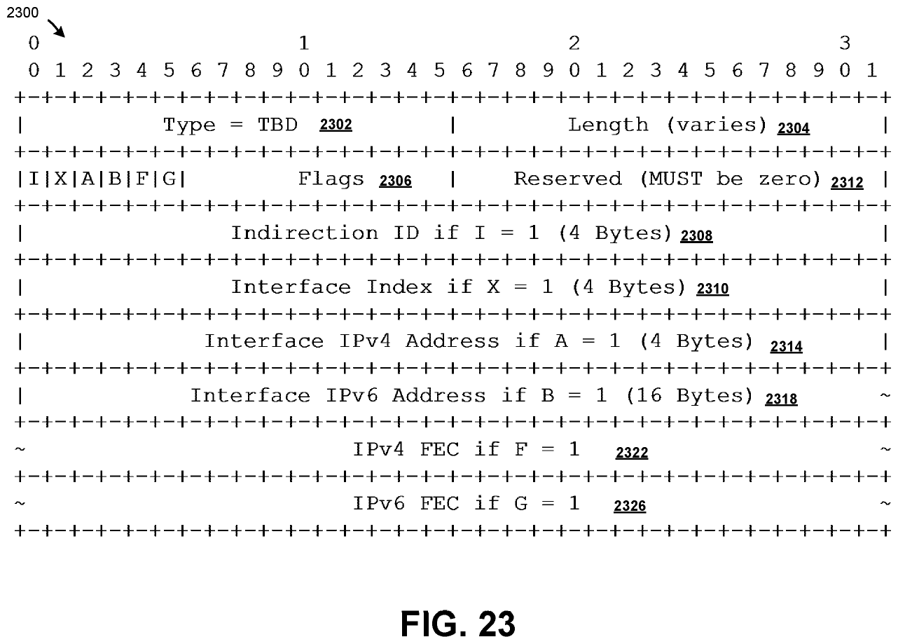

FIG. 23 is a schematic diagram illustrating a Traffic-Description sub-TLV 2300 according to another embodiment of the present disclosure. The Traffic-Description sub-TLV 2300 is another example a sub-TLV for traffic description, such as, the Traffic-Description sub-TLV 2016 in FIG. 20. The Traffic-Description sub-TLV 2300 includes Type 2302, Length 2304, and flags 2306. The Type 2302 specifies a value (TBD) that indicates that the sub-TLV is a Traffic-Description sub-TLV 2300. The Length 2304 specifies the length of the Traffic-Description sub-TLV 2300 excluding the Type 2302 and Length 2304 fields. The Traffic-Description sub-TLV 2300 also includes Reserved field 2312 that is reserved for future use.

Similar to the Traffic-Description sub-TLV 2100, the Traffic-Description sub-TLV 2300 includes an Indirection ID 2308 of 32 bits (i.e., 4 bytes) if the Indirection ID flag (I flag) in the flags 2306 is set to one (1). The I flag is set to zero (0) to indicate that no Indirection ID 2308 is included in the Traffic-Description sub-TLV 2300. The Traffic-Description sub-TLV 2300 includes an Interface Index 2310 of 32 bits (i.e., 4 bytes) if the Interface Index flag (X flag) in the flags 2306 is set to one (1). The X flag is set to zero (0) to indicate that no Interface Index 2310 is included in the Traffic-Description sub-TLV 2300. The Traffic-Description sub-TLV 2300 includes an Interface IPv4 Address 2314 of 32 bits (i.e., 4 bytes) if the Interface IPv4 Address flag (A Flag) in the flags 2306 is set to one (1). The A Flag is set to zero (0) to indicate that no Interface IPv4 Address 2314 is included in the Traffic-Description sub-TLV 2300. The Traffic-Description sub-TLV 2300 includes an Interface IPv6 Address 2318 of 128 bits (i.e., 16 bytes) if the Interface IPv6 Address flag (B Flag) in the flags 2306 is set to one (1). The B Flag is set to zero (0) to indicate that no Interface IPv6 Address 2318 is included in the Traffic-Description sub-TLV 2300. The Traffic-Description sub-TLV 2300 includes an IPv4 FEC 2322 if the IPv4 FEC flag (F Flag) in the flags 2306 is set to one (1). The F Flag is set to zero (0) to indicate that no IPv4 FEC 2322 is included in the Traffic-Description sub-TLV 2300. The Traffic-Description sub-TLV 2300 includes an IPv6 FEC 2326 if the IPv6 FEC flag (G Flag) in the flags 2306 is set to one (1). The G Flag is set to zero (0) to indicate that no IPv6 FEC 2326 is included in the Traffic-Description sub-TLV 2300.

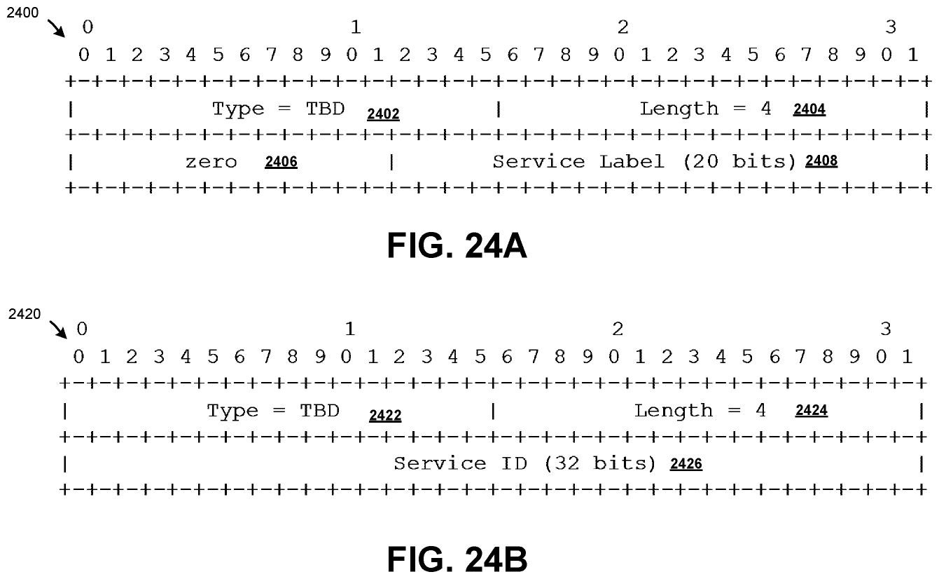

FIG. 24A and FIG. 24B illustrate two examples of a Service sub-TLV that is used to specify a particular service according to an embodiment of the present disclosure. FIG. 24A illustrates a Service Label sub-TLV 2400 that is used to identify a service using a service label. For example, the Service Label sub-TLV 2400 includes a Type 2402, Length 2404, Zero 2406, and a Service Label 2408. The Type 2402 specifies a value (TBD) that indicates that the Service sub-TLV is a Service Label sub-TLV 2400. The Length 2404 specifies the length of the Service Label sub-TLV 2400 excluding the Type 2402 and Length 2404 fields. The Zero 2406 field contains all zeros. In an embodiment, the Service Label 2408 is a label of the least significant 20 bits of a 32-bit word.

FIG. 24B illustrates a Service ID sub-TLV 2420 that is used to identify a service using a service identifier. The Service ID sub-TLV 2420 includes a Type 2422, Length 2424, and a Service ID 2426. The Type 2422 specifies a value (TBD) that indicates that the Service sub-TLV is a Service ID sub-TLV 2420. The Length 2424 specifies the length of the Service ID sub-TLV 2420 excluding the Type 2422 and Length 2424 fields. In an embodiment, the Service ID 2426 is an Identifier of a service represented in a 32-bit word.

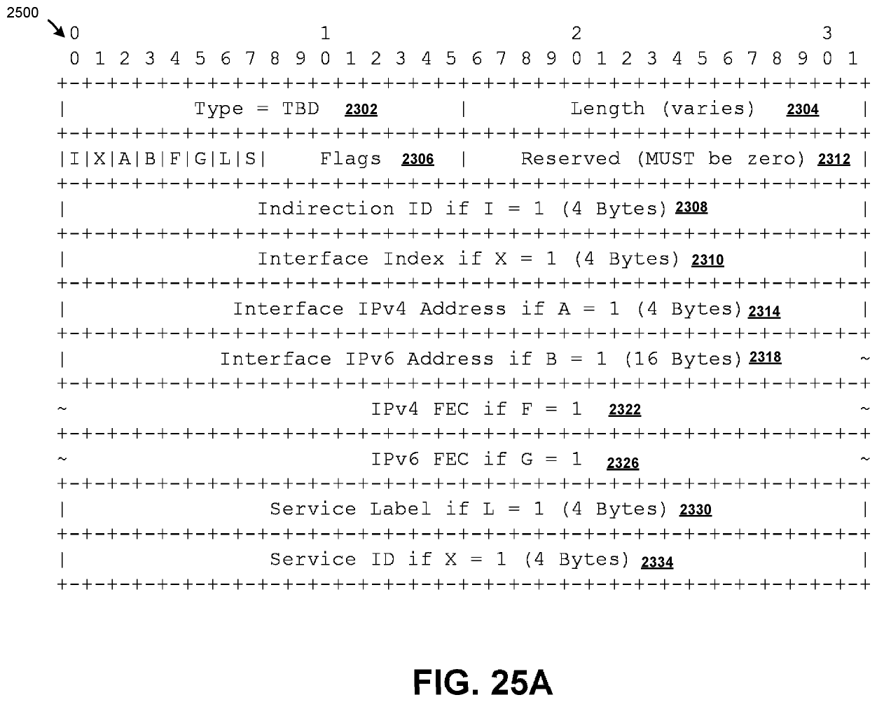

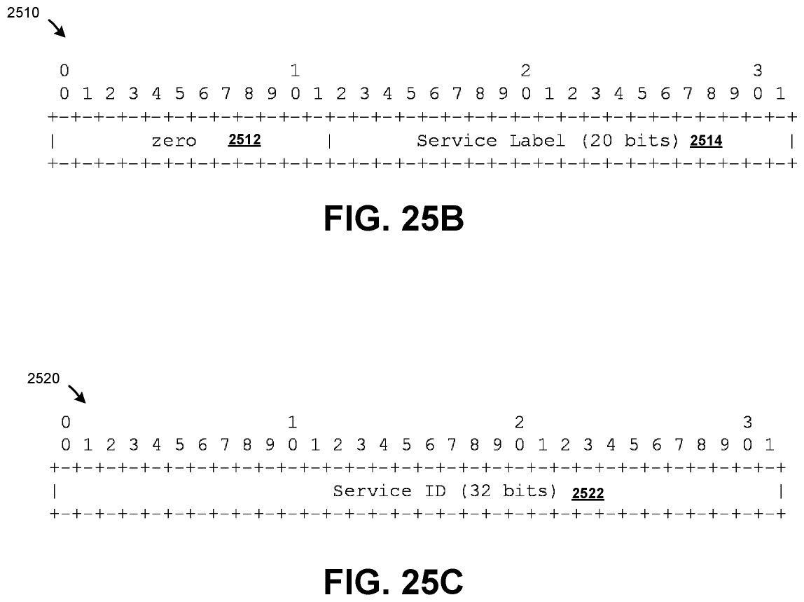

FIG. 25A is a schematic diagram illustrating a Traffic-Description sub-TLV 2500 according to another embodiment of the present disclosure. All the fields of the Traffic-Description sub-TLV 2500 are similar to the Traffic-Description sub-TLV 2300 in FIG. 23, except that flags 2306 have two new flags, an L Flag and an S Flag. The L flag is a service Label flag. The L flag is set to one (1) to indicate that a Service Label 2330 is included in the Traffic Description sub-TLV 2500. In an embodiment, the Service Label 2330 is 32 bits (i.e., 4 bytes). The L flag is set to zero (0) to indicate that no Service Label 2330 is included in the Traffic Description sub-TLV 2500. The S flag is Service ID flag. The S flag is set to one (1) to indicate that a Service ID 2334 is included in the Traffic Description sub-TLV 2500. In an embodiment, the Service ID 2334 is 32 bits (i.e., 4 bytes). The S flag is set to zero (0) to indicate that no Service ID 2334 is included in the Traffic Description sub-TLV 2500.

FIG. 25B is a schematic diagram illustrating a Service Label 2510 encoding according to an embodiment of the present disclosure. The Service Label 2510 includes a zero field 2512 that is set to all zeros, and a 20-bit field for a service label 2514. FIG. 25C is a schematic diagram illustrating a Service ID 2520 encoding according to an embodiment of the present disclosure. The Service ID 2520 includes a 32-bit field for a Service ID 2522.

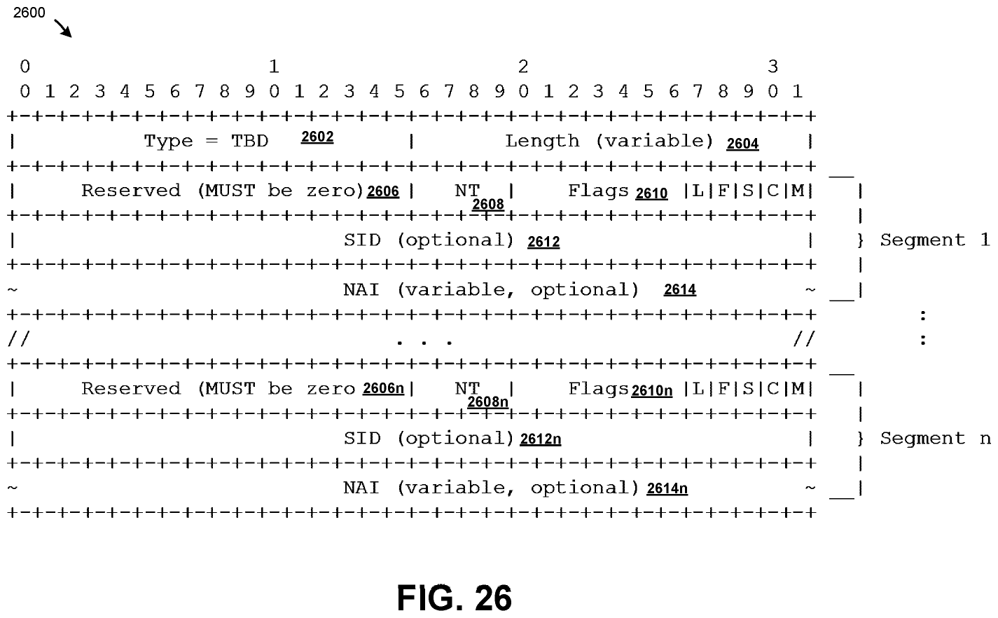

FIG. 26 is a schematic diagram illustrating sub-TLVs for a SID list (SID List sub-TLV 2600) according to an embodiment of the present disclosure. In the embodiment of FIG. 26, the SID List sub-TLV 2600 includes a type 2602 and length 2604. The type 2602 specifies a value (TBD) that indicates that the sub-TLV is a SID List sub-TLV 2600. The length 2604 specifies the length of the SID List sub-TLV 2600 excluding the type 2602 and length 2604 fields. The SID List sub-TLV 2600 includes the encoding for one (e.g., Segment 1) or more Segments (Segment n). Each Segment encoding includes a Reserved 2606, Node or Adjacency Identifier (NAI) Type (NT) 2608, flags 2610, SID 2612, and NAI 2614. The Reserved 2606 is reserved for future use.

The NT 2608 indicates a type and format of the NAI associated with the SID contained in the SID list sub-TLV 2600. In an embodiment, the following NT values are defined: NT=0 means the NAI is absent, NT=1 means the NAI is an IPv4 node ID, NT=2 means the NAI is an IPv6 node ID, NT=3 means the NAI is an IPv4 adjacency, NT=4 means the NAI is an IPv6 adjacency, and NT=5 means the NAI is an unnumbered adjacency with IPv4 node IDs.

In an embodiment, flags 2610 for a segment are defined as follows:

L flag: It indicates whether the segment represents a loose-hop. If this flag is set to zero, the network node MUST NOT overwrite the SID value present in the segment. Otherwise, the network node MAY expand or replace one or more SID values in the received SID list based on its local policy.

F flag: When this bit is set to 1, the NAI value in the segment is absent. The F bit MUST be set to 1 if NT=0, and otherwise MUST be set to zero. The NAI's format depends on the value in the NT field.

S flag: When this bit is set to 1, the SID value in the segment is absent. In this case, the network node is responsible for choosing the SID value, e.g., by looking up in its Link State Database (LSDB) using the NAI which, in this case, MUST be present in the segment. The S and F bits must not both be set to 1. If the S bit is set to 1 then the M and C bits MUST be set to zero.

C flag: If the M bit and the C bit are both set to 1, then the TC, S, and TTL fields in the Multiprotocol Label Switching (MPLS) label stack entry are specified by the BGP-LS as a SDN controller. However, the network node MAY choose to override these values according its local policy and MPLS forwarding rules. If the M bit is set to 1 but the C bit is set to zero, then the TC, S, and TTL fields MUST be ignored by the node. The node MUST set these fields according to its local policy and MPLS forwarding rules. If the M bit is set to zero then the C bit MUST be set to zero.

M flag: If this bit is set to 1, the SID value represents an MPLS label stack entry as specified in RFC 3032. Otherwise, the SID value is an administratively configured value which acts as an index into an MPLS label space. SID is the Segment Identifier.

The SID List sub-TLV 2600 includes information about the SR tunnel in an ordered list of SIDs 2612 and optionally NAI 2614. In an embodiment, an alternative embodiment, the SID List sub-TLV 2600 includes information about the SR tunnel in an ordered list of MPLS labels and IP addresses. In this case, the network node needs to convert the IP addresses into the corresponding SIDs 2612 by consulting the LSDB of the network node and an ordered list of IP addresses representing network nodes/links. If needed, the network node can convert the IP addresses into the corresponding MPLS labels using LSDB.

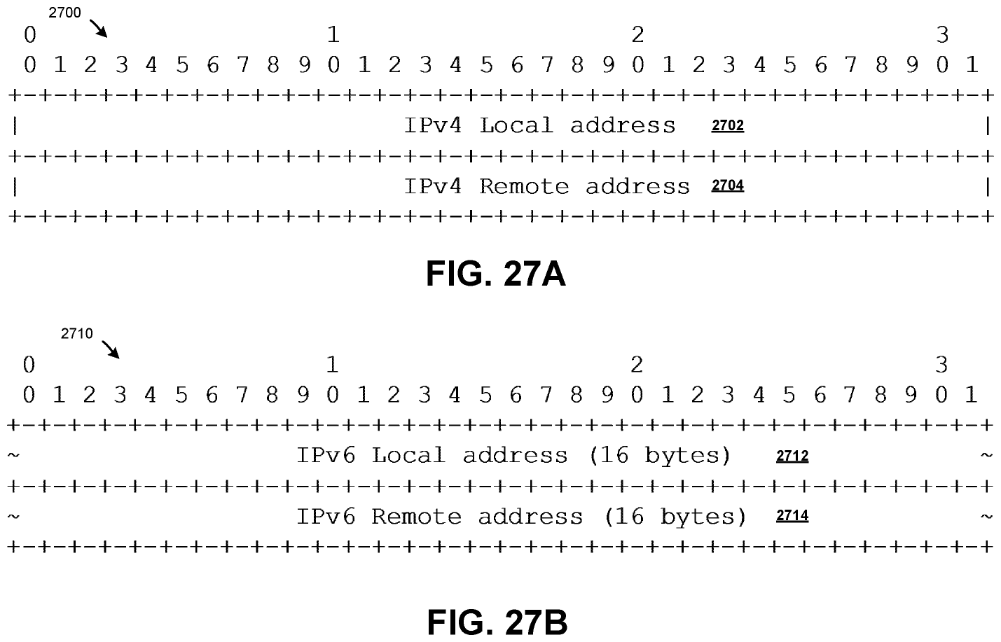

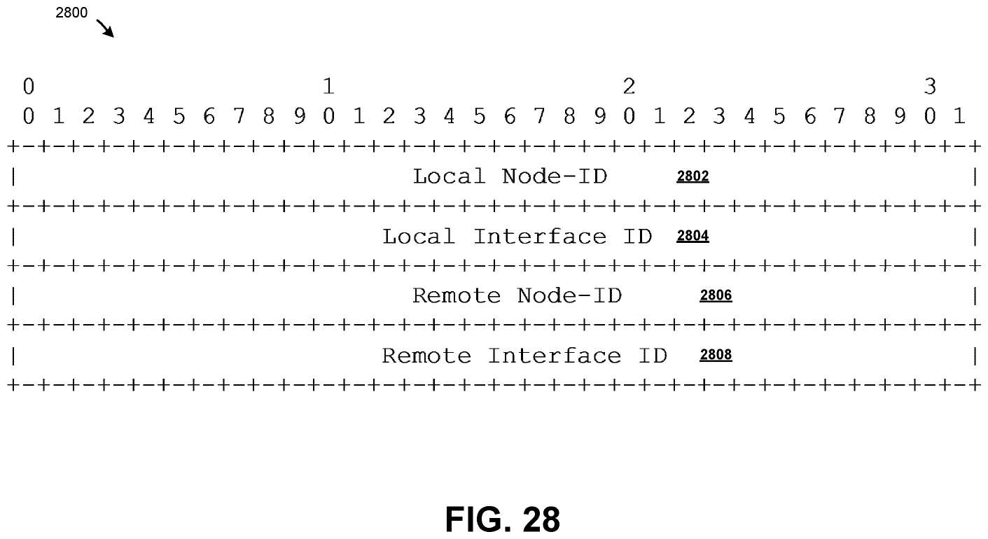

The NAI 2614 contains the NAI associated with the SID. The format of the NAI 2614 depends on the value in the NT 2608 field. In an embodiment, if NT=0, then the NAI is absent; if NT=1, then the NAI is an IPv4 node ID of 32 bits; if NT=2, then the NAI is an IPv6 node ID of 128 bits; if NT=3, then the NAI is an IPv4 adjacency containing an IPv4 local address and an IPv4 remote address (FIG. 27A); if NT=4, then the NAI is an IPv6 adjacency containing an IPv6 local address and an IPv6 remote address (FIG. 27B); and if NT=5, then the NAI is an unnumbered adjacency with IPv4 node IDs containing a pair of Node ID/Interface ID tuples (FIG. 28).

FIG. 27A is a schematic diagram illustrating an NAI IPv4 Adjacency 2700 data structure according to an embodiment of the present disclosure. The NAI IPv4 Adjacency 2700 includes an IPv4 local address 2702 and an IPv4 remote address 2704.

FIG. 27B is a schematic diagram illustrating NAI IPv6 Adjacency 2710 data structure according to an embodiment of the present disclosure. The NAI IPv6 Adjacency 2710 includes an IPv6 local address 2712 and an IPv6 remote address 2714.

FIG. 28 is a schematic diagram illustrating a NAI unnumbered adjacency with IPv4 node IDs 2800 according to an embodiment of the present disclosure. The NAI unnumbered adjacency with IPv4 node IDs 2800 includes a pair of Node ID/Interface ID tuples comprising a Local Node-ID 2802, Local Interface ID 2804, Remote Node-ID 2806, and Remote Interface ID 2808.

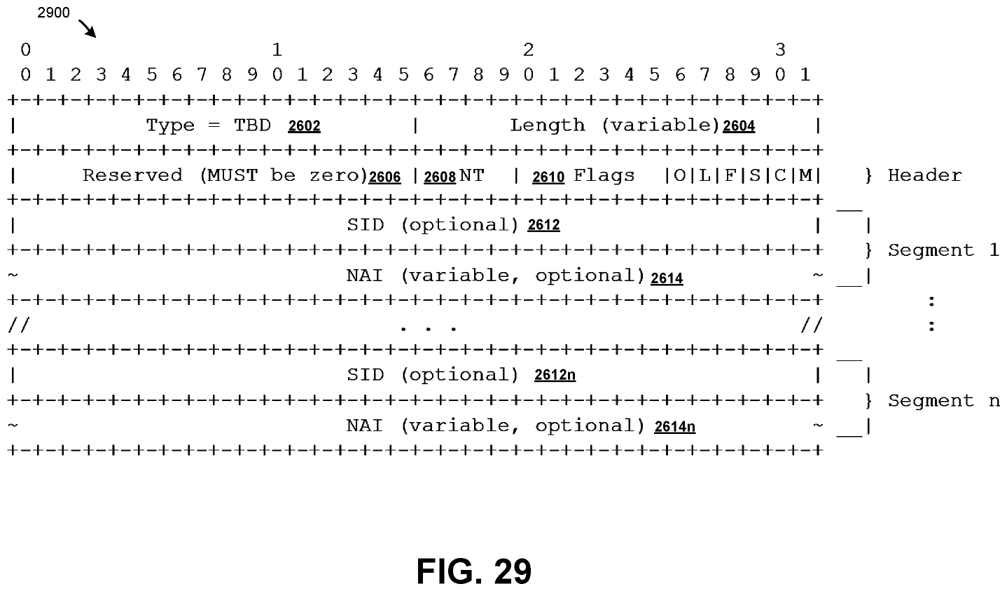

FIG. 29 is a schematic diagram illustrating SID List sub-TLV 2900 according to another an embodiment of the present disclosure. The SID List sub-TLV 2900 is similar to the SID List sub-TLV 2600 in FIG. 26, except that a new “O” flag in the Flags 2610 field is defined. In an embodiment, if the O flag set to one (1), then it indicates that every segment (Segment 1 through Segment n) uses the same header (i.e., Reserved 2606, NAI Type (NT) 2608, and flags 2610) as opposed to each segment having their own header as illustrated in FIG. 26. In another embodiment, every segment in the SID List sub-TLV 2900 uses the same header without the need for a special flag (i.e., the new “O” flag). In an embodiment, the SID List sub-TLV 2900 has a header of 32 bits.

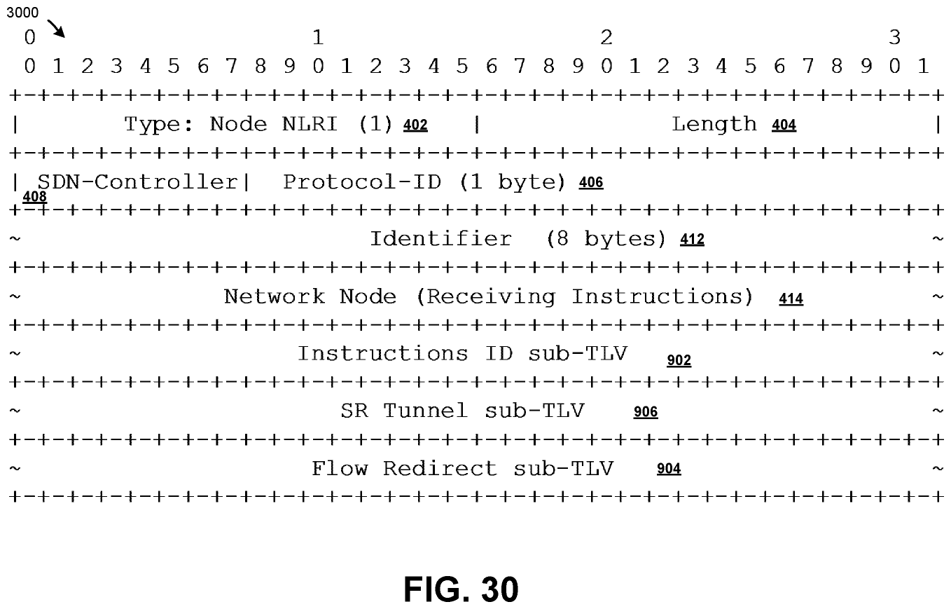

FIG. 30 is a schematic diagram illustrating an example of an Instructions TLV 3000 according to an embodiment of the present disclosure. The Instructions TLV 3000 is similar to the Instructions TLV 900 in FIG. 9, in that it includes an Instructions ID sub-TLV 902, followed by the Flow Redirect sub-TLV 904. However, the Instructions TLV 3000 also includes a SR Tunnel sub-TLV 906 for creating a SR tunnel. The Flow Redirect sub-TLV 904 is for redirecting a traffic flow to the SR tunnel. In an embodiment, the Indirection ID contained in SR Tunnel sub-TLV 906 is the same as that in Flow Redirect sub-TLV 904.

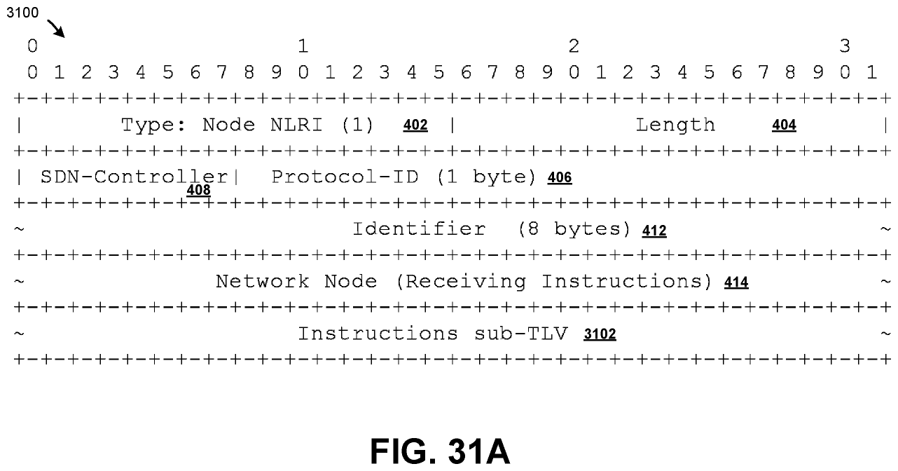

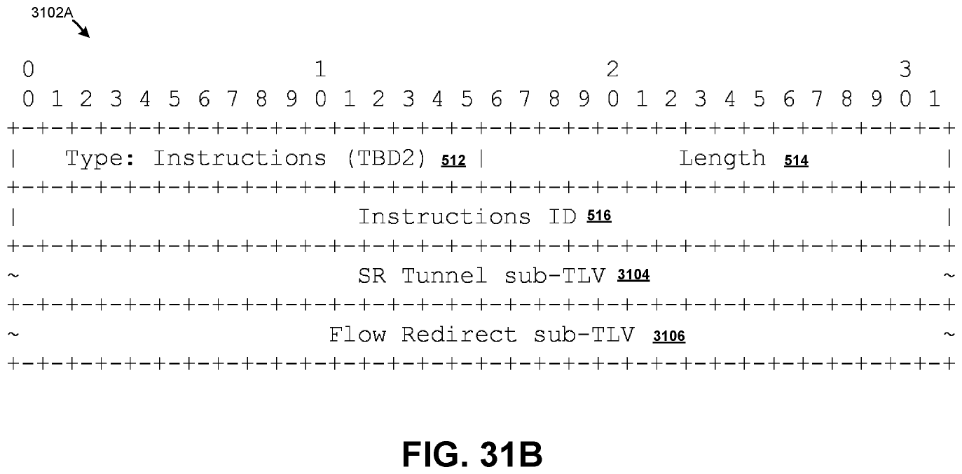

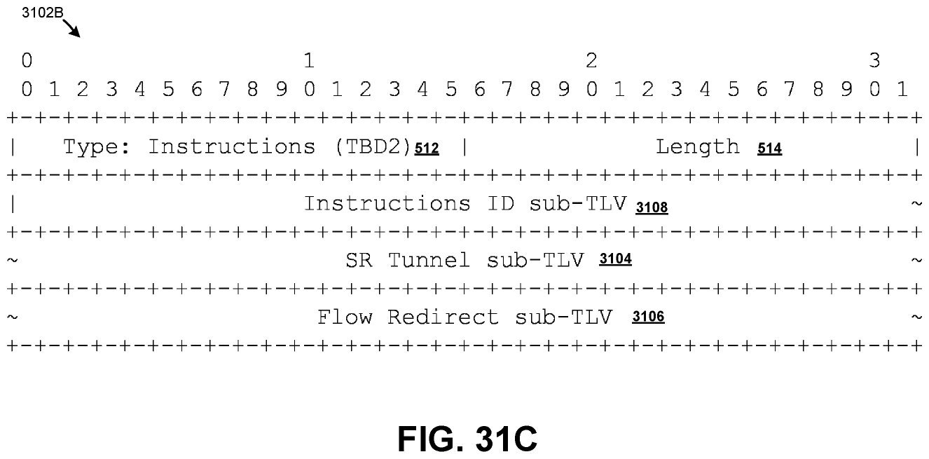

FIG. 31A is a schematic diagram illustrating an Instructions TLV 3100 according to another embodiment of the present disclosure. In the depicted embodiment, the Instructions TLV 3100 includes Type 402, Length 404, SDN Controller 408, which is a Protocol-ID 1406 of one byte, Identifier 412, and Network Node 414 fields as described in the Instructions TLV 400 in FIG. 4. For instructions, the Instructions TLV 3100 does not directly contain any Instructions ID sub-TLV. Instead, the Instructions TLV 3100 contains an Instructions sub-TLV 3102 that can directly or indirectly (e.g., an Instructions ID sub-TLV) contains an Instructions ID.

As an example, FIG. 31B illustrates an Instructions sub-TLV 3102A that directly contains an Instructions ID according to an embodiment of the present disclosure. The Instructions sub-TLV 3102A can be used as an Instructions sub-TLV 3102 in the Instructions TLV 3100 of FIG. 31A. In the depicted embodiment, the Instructions sub-TLV 3102A includes Type 512, Length 514, and Instructions ID 516. The Instructions ID 516 is a 32-bits identifier which identifies a set of instructions. For instructions, the Instructions sub-TLV 3102A includes a SR Tunnel sub-TLV 3104 and a Flow Redirect sub-TLV 3106. An example of the SR Tunnel sub-TLV 3104 is the SR Tunnel sub-TLV 2000 in FIG. 20. An example of the Flow Redirect sub-TLV 3106 is the Flow Redirect sub-TLV 800 in FIG. 8A. The Instructions sub-TLV 3102A can also include other Instructions sub-TLVs.

FIG. 31C is a schematic diagram illustrating an example of an Instructions sub-TLV 3102B that indirectly contains an Instructions ID according to an embodiment of the present disclosure. The Instructions sub-TLV 3102B can be used as an Instructions sub-TLV 3102 in the Instructions TLV 3100 of FIG. 31A. In the depicted embodiment, the Instructions sub-TLV 3102B includes Type 512 and Length 514 as described in the Instructions sub-TLV 510 in FIG. 5A. The Instructions sub-TLV 3102B includes an Instructions ID sub-TLV 3108, which contains an Instructions ID. An example of the Instructions ID sub-TLV 3108 is the Instructions ID sub-TLV 500 in FIG. 5A. For instructions, the Instructions sub-TLV 3102B includes the SR Tunnel sub-TLV 3104 and the Flow Redirect sub-TLV 3106 as described in FIG. 31B. The Instructions sub-TLV 3102B can also include other Instructions sub-TLVs.

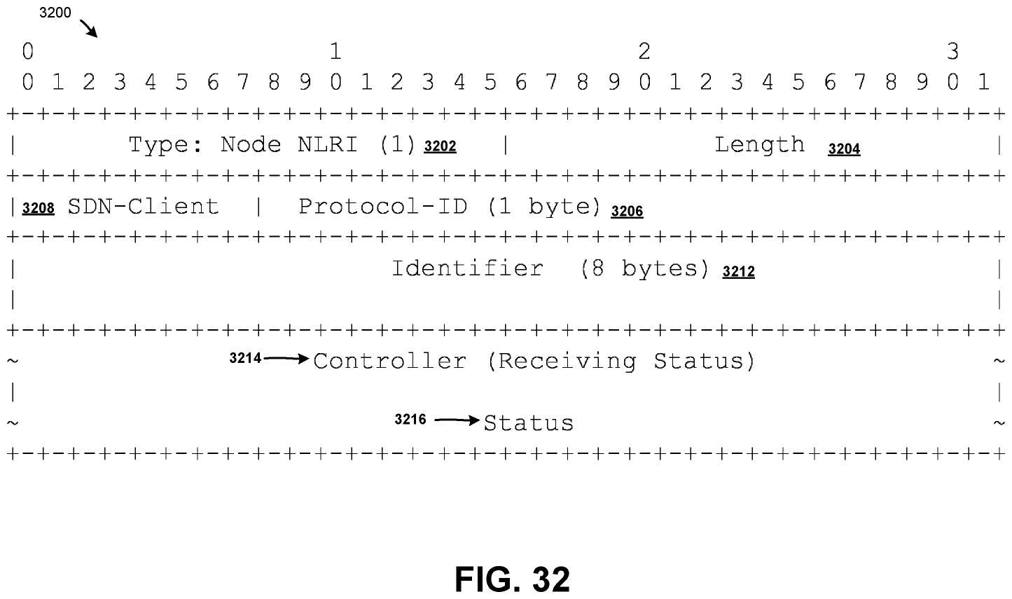

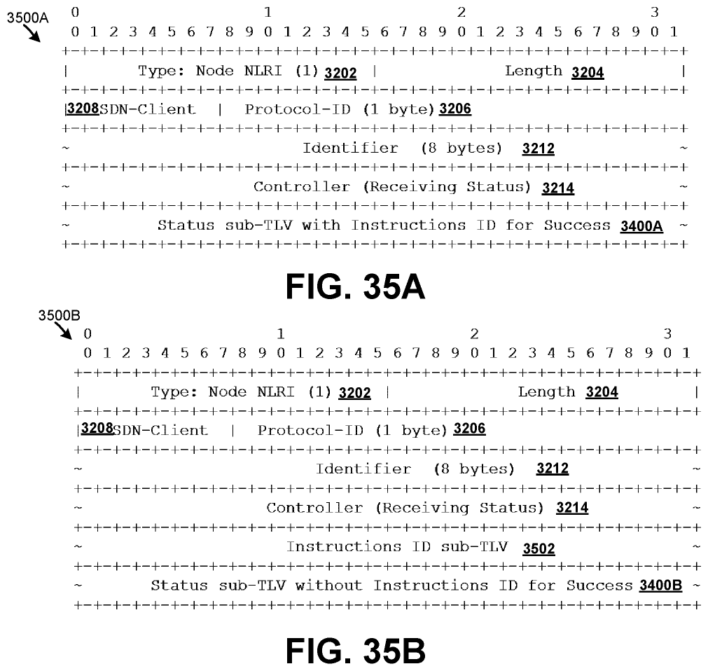

FIG. 32 is a schematic diagram illustrating a Status TLV 3200 according to an embodiment of the present disclosure. In an embodiment, after a node executes instructions received from a controller, it sends the status of the execution to the controller using the Status TLV 3200. The Status TLV 3200 reuses the format of the Node NLRI TLV defined in BGP-LS (RFC 7752). The Status TLV 3200 includes the type 3202 field, and length 3204 field that specifies a length of the Status TLV 3200, excluding the type 3202 and length 3204 fields. The Status TLV 3200 defines/uses a new Protocol-ID 3206, called SDN Client 3208. The Status TLV 3200 contains a Status 3216 and a Controller 3214 to which the node sends the status. The Identifier 3212 and the information about the Controller 3214 uniquely identify a controller (or a controller instance) in a network. The latter may reuse the (local) node descriptor defined in BGP-LS RFC 7752. The Status 3216 may contain one or more Status sub-TLVs as illustrated in FIG. 35A and FIG. 35B.

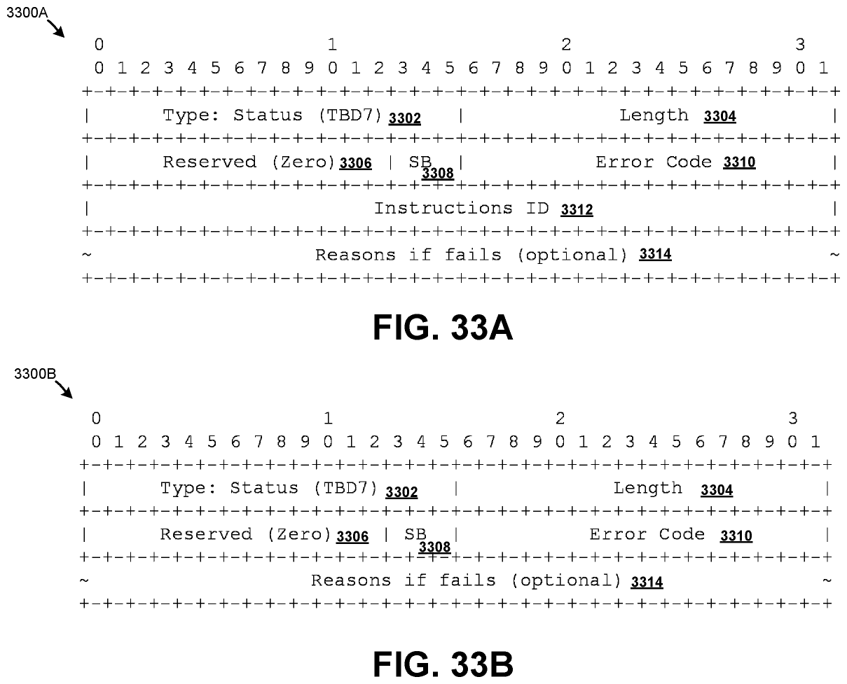

As an example, FIG. 33A is a schematic diagram illustrating Status sub-TLV 3300A according to an embodiment of the present disclosure. The Status sub-TLV 3300A includes the following fields: Type 3302, Length 3304, Reserved 3306, Status Brief (SB) 3308, Error Code 3310, Instructions ID 3312, and Reasons if fails 3314. The Type 3302 specifies a value (TBD) that indicates that the data structure type is a Status sub-TLV. The Length 3304 specifies the length of the Status sub-TLV 3300A, excluding the Type 3302 and Length 3304 fields. The Reserved 3306 is reserved for future use and contain all zeros (0). The SB 3308 provides a status of the execution of the control instructions. In one embodiment, the SB 3308 can utilize the following coding scheme to indicate the status of execution of the control instructions: x001 Successful: All instructions execute successfully; x010 Failed: Executions of all instructions failed; and x011 Partial: Some instructions execute successfully, but executions of some instructions failed. The Error Code 3310 can be used to indicate a type of error. In an embodiment, the Instructions ID 3312 contains a 32-bit Instructions ID. The 32-bit Instructions ID may be in a separated sub-TLV or embedded into the Status sub-TLV 3300A. The Reasons if fails 3314 option contains a reason why one or more instructions failed.

FIG. 33B is a schematic diagram illustrating Status sub-TLV 3300B according to an embodiment of the present disclosure. The Status sub-TLV 3300B is similar to the Status sub-TLV 3300A in FIG. 33A, except that it does not include the Instructions ID 3312. In this case, an Instructions ID sub-TLV containing an Instructions ID may be included in the Status TLV 3500B (example depicted in FIG. 35B).

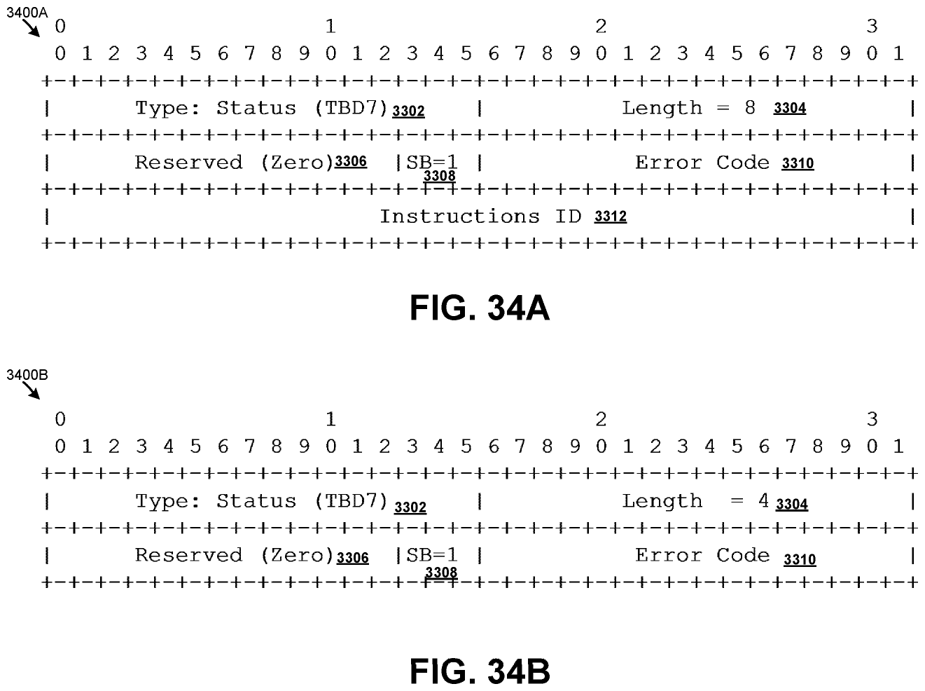

FIG. 34A is a schematic diagram illustrating a Status sub-TLV 3400A according to an embodiment of the present disclosure. The Status sub-TLV 3400A is an implementation of the Status sub-TLV 3300A in FIG. 33A. In particular, the client sends the controller the Status sub-TLV 3400A with SB 3308 equal to one (SB=1) to indicate that all the instructions from a controller are executed on a node (SDN client) successfully. The Status sub-TLV 3400A also includes the Instructions ID 3312 field containing an Instructions ID. Because all of the instructions are executed successfully, the Status sub-TLV 3400A does not contain any Reasons if fails 3314 as shown in FIG. 33A.

FIG. 34B is a schematic diagram illustrating a Status sub-TLV 3400B according to an embodiment of the present disclosure. The Status sub-TLV 3400B is an implementation of the Status sub-TLV 3300B in FIG. 33B. In particular, the client sends the controller the Status sub-TLV 3400B with SB 3308 equal to one (SB=1) to indicate that all the instructions from a controller are executed on a node (SDN client) successfully. The Status sub-TLV 3400B does not include the Instructions ID 3312 field containing an Instructions ID. Because all of the instructions are executed successfully, the Status sub-TLV 3400B also does not contain any Reasons if fails 3314 as shown in FIG. 33B.

FIG. 35A is a schematic diagram illustrating a Status TLV 3500A according to an embodiment of the present disclosure. The Status TLV 3500A is an example implementation of the Status TLV 3200 in FIG. 32. The Status TLV 3500A contains the Status sub-TLV 3400A (with Instructions ID 3312 and SB 3308 indicating all of the instructions are executed successfully (SB=1) as shown in FIG. 34A) in the Status 3216 section of the Status TLV 3200 in FIG. 32.

FIG. 35B is a schematic diagram illustrating a Status TLV 3500B according to an embodiment of the present disclosure. The Status TLV 3500B is another example implementation of the Status TLV 3200 in FIG. 32. The Status TLV 3500B contains the Status sub-TLV 3400B (with no Instructions ID and SB 3308 indicating all of the instructions are executed successfully (SB=1) as shown in FIG. 34B) in the Status 3216 section of the Status TLV 3200 in FIG. 32. In this implementation, an Instructions ID sub-TLV 3502 that contains an Instructions ID is included in the Status TLV 3500B. An example structure of the Instructions ID sub-TLV 3502 is the Instructions ID sub-TLV 500 shown in FIG. 5A.

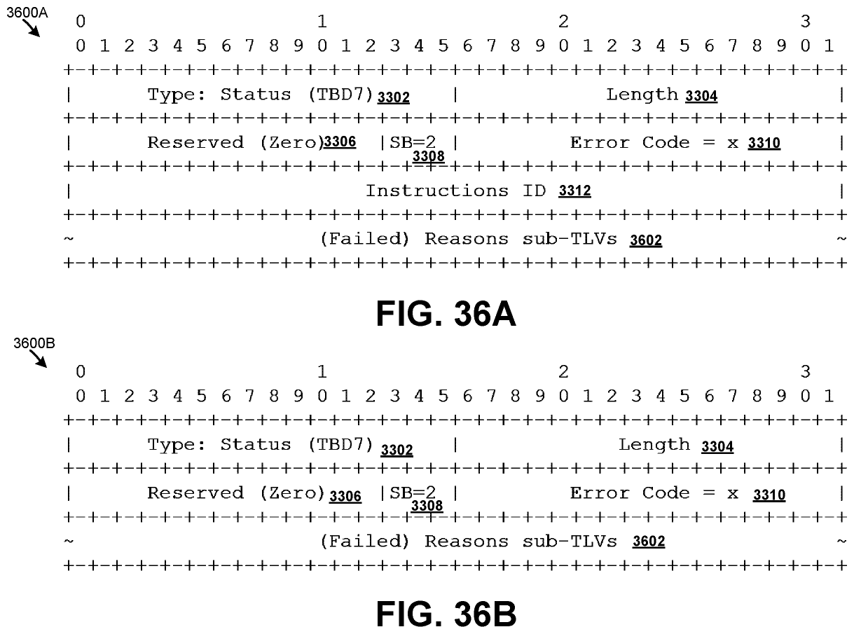

FIG. 36A is a schematic diagram illustrating a Status sub-TLV 3600A according to an embodiment of the present disclosure. The Status sub-TLV 3600A is an implementation of the Status sub-TLV 3300A in FIG. 33A. In particular, the client sends the controller the Status sub-TLV 3600A with SB 3308 equal to two (SB=2) to indicate that all the instructions from a controller failed to execute on the node (SDN client) successfully. The Status sub-TLV 3600A also specifies an error code=x3310 to indicate a particular type of error (TBD). The Status sub-TLV 3600A also includes the Instructions ID 3312 field containing an Instructions ID. To provide reason for the failure in the reasons if fails 3314 field as shown in FIG. 33A, the Status sub-TLV 3600A may contain one or more Reasons sub-TLVs 3602.

FIG. 36B is a schematic diagram illustrating a Status sub-TLV 3600B according to an embodiment of the present disclosure. The Status sub-TLV 3600B is an implementation of the Status sub-TLV 3300B in FIG. 33B. In particular, the client sends the controller the Status sub-TLV 3600B with SB 3308 equal to two (SB=2) to indicate that all the instructions from a controller failed to execute on the node (SDN client) successfully. The Status sub-TLV 3600B also specifies an error code=x3310 to indicate a particular type of error (TBD). The Status sub-TLV 3600B does not include the Instructions ID 3312 field containing an Instructions ID. To provide reason for the failure in the reasons if fails 3314 field as shown in FIG. 33A, the Status sub-TLV 3600A may contain one or more Reasons sub-TLVs 3602.

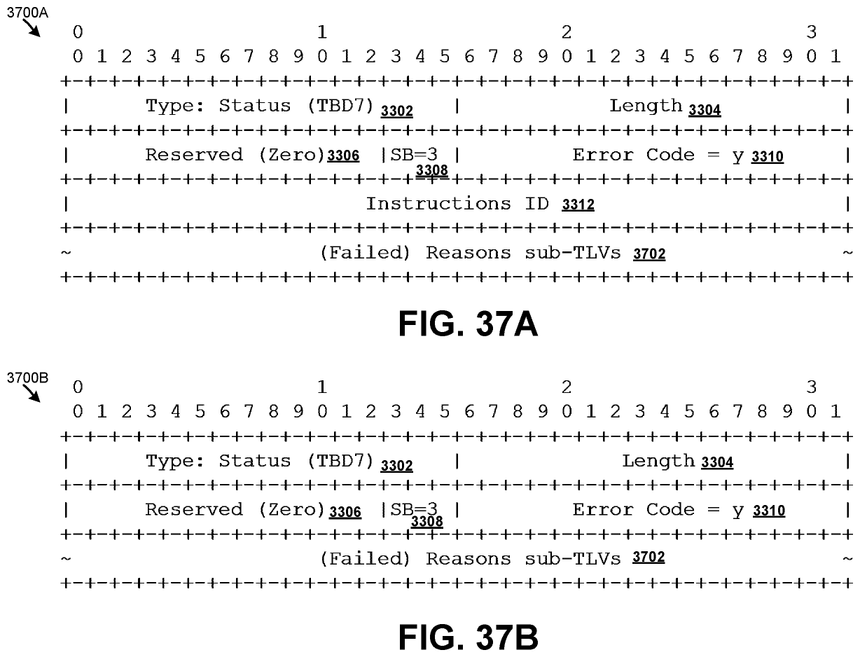

FIG. 37A is a schematic diagram illustrating a Status sub-TLV 3700A according to an embodiment of the present disclosure. The Status sub-TLV 3700A is an implementation of the Status sub-TLV 3300A in FIG. 33A. In particular, the client sends the controller the Status sub-TLV 3700A with SB 3308 equal to three (SB=3) to indicate that part of the instructions from a controller failed to execute on the node (SDN client) successfully (i.e., some instructions execute successfully, but executions of some instructions failed). The Status sub-TLV 3700A also specifies an error code=y 3310 to indicate a particular type of error (TBD). The Status sub-TLV 3700A also includes the Instructions ID 3312 field containing an Instructions ID. To provide reason for the partial failure in the reasons if fails 3314 field as shown in FIG. 33A, the Status sub-TLV 3700A may contain one or more Reasons sub-TLVs 3702.

FIG. 37B is a schematic diagram illustrating a Status sub-TLV 3700B according to an embodiment of the present disclosure. The Status sub-TLV 3700B is an implementation of the Status sub-TLV 3300B in FIG. 33B. In particular, the client sends the controller the Status sub-TLV 3700B with SB 3308 to three (SB=3) to indicate that part of the instructions from a controller failed to execute on the node (SDN client) successfully. The Status sub-TLV 3700B also specifies an error code=y to indicate a particular type of error (TBD). The Status sub-TLV 3700B does not include the Instructions ID 3312 field containing an Instructions ID. To provide reason for the partial failure in the reasons if fails 3314 field as shown in FIG. 33A, the Status sub-TLV 3700A may contain one or more Reasons sub-TLVs 3702.

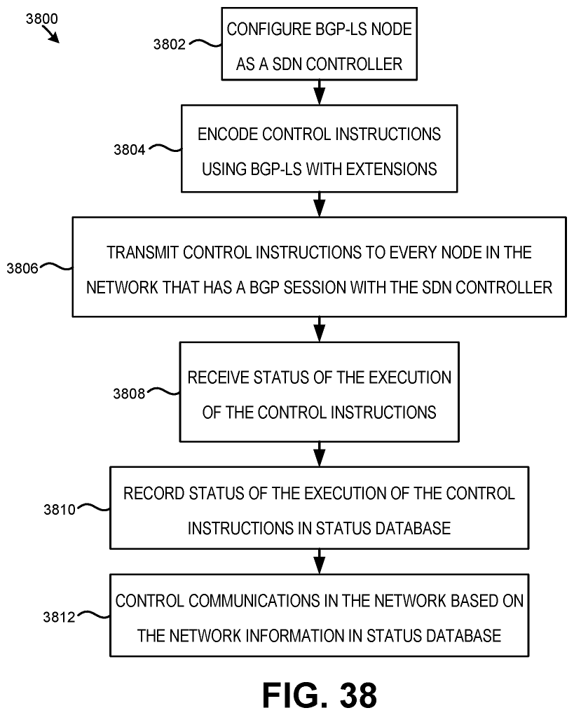

FIG. 38 is a flowchart illustrating a method 3800 for controlling a network according to an embodiment of the present disclosure. The method 3800 can be executed by a BGP-LS network node such as, but not limited to, route reflector 102 or non-route reflector network node 124 in FIG. 2A. The method 3800 begins, at step 3802, by configuring a BGP-LS supported node as a SDN controller. The method 3800, at step 3804, encodes control instructions using BGP-LS with extensions as described herein. At step 3806, the method transmits the control instructions to every node in the network that has a BGP session with the SDN controller and that are identified as intended recipients of the control instructions by the SDN controller based on the particular control instructions. As described above, for a node in the network identified as an intended recipient of the control instructions by the SDN controller that does not have a BGP session with the SDN controller, but has a BGP session with another route reflector, the SDN controller sends the instructions to the other route reflector that has a BGP session with the node, other route reflector then forwards the instructions to the node. For a non-route reflector BGP-LS supported node as an SDN controller, the SDN controller sends the control instructions to a route reflector connected to the SDN controller. The route reflector forwards the instructions to the nodes in the network that it has a BGP session with, or to another route reflector that has a BGP session with the intended node.

At step 3808, the method 3800 receives status of the execution of the control instructions back from the nodes. The method 3800, at step 3810, records the status of the execution of the control instructions in a status database. The method 3800, at step 3812, controls various functions in the network based on the network information in the status database.

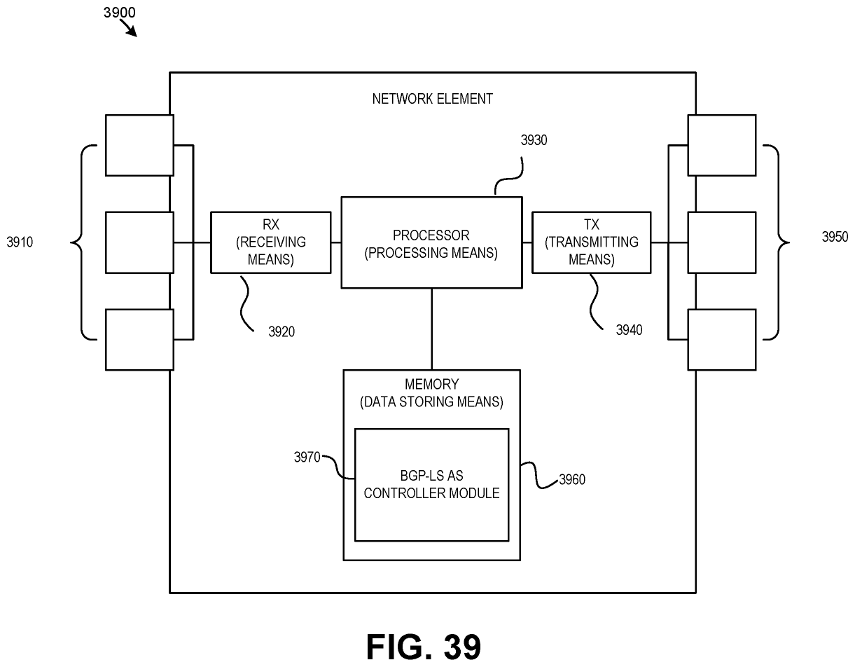

FIG. 39 is a schematic diagram illustrating a hardware architecture of a network element 3900 according to an embodiment of the present disclosure. The network element 3900 can be any type of network device or node such as, but not limited to, route reflector 102, route reflector 122, or non-route reflector network node 124 in FIG. 2A. The network element 3900 includes receiver units (RX) 3920 or receiving means for receiving data via ingress ports 3910. The network element 3900 also includes transmitter units (TX) 3940 or transmitting means for transmitting via data egress ports 3950.

The network element 3900 includes a memory 3960 or data storing means for storing the instructions and various data. The memory 3960 can be any type of or combination of memory components capable of storing data and/or instructions. For example, the memory 3960 can include volatile and/or non-volatile memory such as read-only memory (ROM), random access memory (RAM), ternary content-addressable memory (TCAM), and/or static random-access memory (SRAM). The memory 3960 can also include one or more disks, tape drives, and solid-state drives. In some embodiments, the memory 3960 can be used as an over-flow data storage device to store programs when such programs are selected for execution, and to store instructions and data that are read during program execution.

The network element 3900 has one or more processor 3930 or other processing means (e.g., central processing unit (CPU)) to process instructions. The processor 3930 may be implemented as one or more CPU chips, cores (e.g., as a multi-core processor), field-programmable gate arrays (FPGAs), application specific integrated circuits (ASICs), and digital signal processors (DSPs). The processor 3930 is communicatively coupled via a system bus with the ingress ports 3910, RX 3920, TX 3940, egress ports 3950, and memory 3960. The processor 3930 can be configured to execute instructions stored in the memory 3960. Thus, the processor 3930 provides a means for performing any computational, comparison, determination, initiation, or configuration (e.g., setting the F-bit or I-bit) steps, or any other action, corresponding to the claims when the appropriate instruction is executed by the processor. In some embodiments, the memory 3960 can be memory that is integrated with the processor 3930.

In one embodiment, the memory 3960 stores a BGP-LS as controller module 3970. The BGP-LS as controller module 3970 includes data and executable instructions for implementing the disclosed embodiments. For instance, the BGP-LS as controller module 3970 can include instructions for implementing the method 3800 described in FIG. 38 using the BGP-LS data structures described herein. The inclusion of the BGP-LS as controller module 3970 substantially improves the functionality of the network element 3900 by enabling the use of BGP-LS as an SDN controller, and thereby eliminating the requirement to deploy PCE protocol for use as a controller.

The disclosed embodiments provide an efficient solution for controlling a network that does not exist today by enabling BGP-LS to be used as a central/SDN controller. The disclosed embodiments eliminate the need to deploy PCE as a central controller, which requires that the PCE protocol be deployed in the network. This process is complex and expensive, and requires that that a PCE be configured to obtain information about the network topology from other protocols such as BGP-LS. Thus, the disclosed embodiments provide a useful, efficient, and practical application for controlling a network.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method by a Border Gateway Protocol-Link State (BGP-LS) supported node configured to act as a central controller using extended BGP-LS protocol instructions for controlling a network, the method comprising:
encoding control instructions using the extended BGP-LS protocol instructions; and
transmitting the control instructions to intended recipient nodes in the network that have established a BGP session with the BGP-LS supported node.

2. The method according to claim 1, wherein the BGP-LS supported node is a first route reflector node.

3. The method of claim 2, further comprising:
transmitting the control instructions to a second route reflector node, which sends the control instructions to other nodes in the network that do not have a BGP session with the first route reflector node, and that have a BGP session with the second route reflector node.

4. The method of claim 3, further comprising:
receiving a status of an execution of the control instructions from a node in the network, the status encoded using the extended BGP-LS protocol, and
recording the status of the execution of the control instructions from the node in the network in a status database.

5. The method of claim 4, further comprising:
receiving via the second route reflector node, the status of the execution of the control instructions from the node in the network; and
recording the status of the execution of the control instructions from the node in the network in the status database.

6. The method of claim 4, wherein the extended BGP-LS protocol of the control instructions comprise an Instructions Type-Length-Value (TLV) based on a Network Layer Reachability Information (NLRI) node TLV encoding format defined in BGP-LS.

7. The method of claim 6, wherein the extended BGP-LS protocol of the Instructions TLV comprises a new Protocol-ID, called central Controller, information to identify the node in the network, and instructions encoding.

8. The method of claim 7, wherein the instructions encoding of the Instructions TLV comprises instructions contents.

9. The method of claim 8, wherein the instructions encoding of the Instructions TLV comprises an Instructions ID.

10. The method of claim 9, wherein the extended BGP-LS protocol containing the status comprises the Instructions ID when the instructions encoding includes the Instructions ID.

11. The method of claim 9, wherein the extended BGP-LS protocol containing the status comprises the instructions contents when the instructions encoding does not include the Instructions ID.

12. The method of claim 9, wherein the Instructions ID is a 32-bit identifier contained in an Instructions ID sub-TLV, and wherein the Instructions ID sub-TLV is included in an Instructions TLV.

13. The method of claim 9, wherein the Instructions ID is contained in a 32-bit identifier field of an Instructions sub-TLV, wherein the Instructions sub-TLV is included in an Instructions TLV.

14. The method of claim 9, wherein the instructions contents are encoded in Instructions sub-TLVs, each Instructions sub-TLV containing a set of instructions to be applied to the node.

15. The method of claim 14, wherein the Instructions TLV comprises a Link Descriptor indicating a link to which the set of instructions are applied.

16. The method of claim 14, wherein the Instructions TLV comprises a Prefix Descriptor indicating a prefix to which the set of instructions are applied.

17. The method of claim 9, wherein the instructions contents are encoded as a set of instructions to be applied to the node in an Instructions sub-TLV, the Instructions sub-TLV being an independent sub-TLV that does not include the Instructions ID, and wherein the Instructions sub-TLV is included in a Node NLRI Instructions TLV.

18. The method of claim 9, wherein the instructions contents are encoded as a set of instructions to be applied to a link in an Instructions sub-TLV, the Instructions sub-TLV being an independent sub-TLV that does not include the Instructions ID, and wherein the Instructions sub-TLV is included in a Link NLRI Instructions TLV.

19. The method of claim 9, wherein the instructions contents are encoded as a set of instructions to be applied to a prefix on a node in an Instructions sub-TLV, the Instructions sub-TLV being an independent sub-TLV that does not include the Instructions ID, and wherein the Instructions sub-TLV is included in a Prefix NLRI Instructions TLV.

20. A method for controlling a network by a network node, the method comprising:
receiving control instructions from a Border Gateway Protocol-Link State (BGP-LS) supported node, the control instructions encoded using an extended BGP-LS protocol;
executing the control instructions;
encoding a status of the execution of the control instructions on the network node using the extended BGP-LS protocol; and
transmitting the status of the execution of the control instructions on the network node to the central controller.

21. The method of claim 20, wherein the status of the execution of the control instructions is included in a Status TLV.

22. The method of claim 21, wherein the Status TLV has a format of a NLRI TLV defined in BGP-LS and comprises a newly defined Protocol-ID, called central Client, a Controller ID, and a Status Sub-TLV.

23. The method of claim 22, wherein the Status Sub-TLV comprises a Status Brief field that indicates a success/failure of execution of the control instructions and comprises an error code field indicating a type of error when a failure is indicated.

24. A network node comprising:
a memory storing instructions;
a processor coupled to the memory, the processor configured to execute the instructions to cause the network node to:
receive control instructions from a Border Gateway Protocol-Link State (BGP-LS) supported node, the control instructions encoded using an extended BGP-LS protocol;
execute the control instructions;
encode a status of the execution of the control instructions on the network node using the extended BGP-LS protocol; and
transmit the status of the execution of the control instructions on the network node to the central controller.

25. The network node of claim 24, wherein the status of the execution of the control instructions is included in a Status TLV.

26. The network node of claim 25, wherein the Status TLV has a format of a NLRI TLV defined in BGP-LS and comprises a newly defined Protocol-ID, called central Client, a Controller ID, and a Status Sub-TLV.

27. The network node of claim 26, wherein the Status Sub-TLV comprises a Status Brief field that indicates a success/failure of execution of the control instructions and comprises an error code field indicating a type of error when a failure is indicated.
